(19) United States
(12) Patent Application Publication
(10) Pub. No.: US 2017/0072812 A1
(43) Pub. Date: Mar. 16, 2017

(54) Battery Management Systems for Autonomous Vehicles

(71) Applicant: QUALCOMM Incorporated, San Diego, CA (US)

(72) Inventors: William Henry Von Novak, San Diego, CA (US); Linda Stacey Irish, San Diego, CA (US)

(21) Appl. No.: 14/855,475

(22) Filed: Sep. 16, 2015

(51) Int. Cl. B60L 11/18; H01M 10/46; H01M 10/44; H01M 10/42

(52) U.S. Cl. CPC B60L 11/1868; H01M 10/4257; H01M 10/46; H01M 10/44; B60L 11/1861; B60L 11/1811; H01M 2010/4271

(57) ABSTRACT

Methods, devices, and circuits are disclosed for managing a high energy density battery and a high power density battery during operational modes in an autonomous vehicle. A power input may be provided from a first battery to a power converter element. A first power output may be provided from the power converter element to power to a second battery and the autonomous vehicle during a first operational mode. A control input to the power converter element may be provided to reduce the first power output in response to determining that one or both of a maximum discharge current threshold and a minimum voltage threshold of the first battery have been exceeded. A second power output may be increased from the second battery to power the autonomous vehicle during a second one of the plurality of operational modes in response to the reduction of the first power output.

### BACKGROUND

As the use of unmanned aircraft (UA), unmanned aerial vehicles (UAVs), drones, and other forms of autonomous vehicles (referred to generally herein as “autonomous vehicle” or “autonomous vehicles”) becomes increasingly common, managing battery power used to power autonomous vehicles become increasingly important.

Many autonomous vehicles (e.g., multirotor drones, quadcopter drones, etc.) are driven by electric motors or other motors that use electric power (e.g., or hybrid drive systems). The drive systems for autonomous vehicles are often powered by battery packs. Autonomous vehicles typically have high overall energy requirements, particularly for long flights and/or flights involving extended loiter times. Multirotor autonomous vehicles require sufficient stored energy to stay aloft for a certain length of time considering energy requirements for many expected flight conditions. Fixed wing autonomous vehicles require sufficient energy to reach and return from their destinations considering energy requirements for expected conditions. Autonomous vehicles may also have high instantaneous power requirements during operations such as takeoff, maneuvering, etc. The combination of high overall energy and high instantaneous power requirements poses battery design and battery management system challenges. For battery design and management purposes, high overall energy requirements and high instantaneous power requirements present design conflicts and tradeoffs.

Of the many battery chemistries and cell designs, most must make tradeoffs between energy density and power density. A lithium-ion battery design might maximize energy density by increasing electrode thickness allowing more active material within the cell. However, increasing electrode thickness increases electrode resistance and reduces power density, because power cannot be drawn as fast from a battery with such a design. Autonomous vehicle battery designs must support a steady energy draw representing a cruise speed (e.g., for a fixed wing autonomous vehicle) or stationary hover (e.g., for a rotor wing autonomous vehicle) along with the conflicting need to support peak power demands. A high energy density battery chemistry/design that maximizes flight time or range can exceed the power density limitations of such as design during peak high power draws (e.g., during takeoff, maneuvering, etc.).

### SUMMARY

Various embodiments include methods, devices for implementing the methods, and circuits for managing a high energy density battery and a high power density battery during a plurality of operational modes in an autonomous vehicle. Various embodiments may include providing a power input from a first battery to a power converter element, providing a first power output from the power converter element to power to a second battery and the autonomous vehicle during a first one of the plurality of operational modes, determining whether one or both of a maximum discharge current threshold and a minimum voltage threshold of the first battery have been exceeded, providing a control input to the power converter element to reduce the first power output in response to determining that one or both of a maximum discharge current threshold and a minimum voltage threshold of the first battery has been exceeded, and increasing a second power output from the second battery to power the autonomous vehicle during a second one of the plurality of operational modes in response to the reduction of the first power output.

Some embodiments may further include providing a charging power output to the second battery during a third one of the plurality of operational modes, determining whether one or both of a maximum charge current threshold and a maximum voltage threshold of the second battery have been exceeded, providing a control input to the power converter element to reduce the charging output to the second battery in response to determining that one or both of a maximum charge current threshold and a maximum voltage threshold of the second battery has been reached, and applying the charging output to the first battery during the third one of the plurality of operational modes in response to the reduction of the charging output to the second battery.

In some embodiments, the third one of the plurality of operational modes may include one of an external charging mode, and a regenerative charging mode. In some embodiments, the first battery comprises the high energy density battery and the second battery may include the high power density battery. In some embodiments, the high energy density battery may include one of a lithium-ion battery, an air-aluminum battery, a fuel cell, a solar cell, and a primary lithium battery, and the high power density battery may include one of a double layer ultracapacitor, a lead-acid battery, and a lithium iron phosphate battery. In some embodiments, the first battery may be the high energy density battery and the second battery may be the high power density battery. In some embodiments, the first one of the plurality of operational modes may include one of a translational flight mode and a loitering flight mode. In some embodiments, the second one of the plurality of operational modes may include one of a takeoff mode and a landing mode.

A power control element for managing a high energy density battery and a high power density battery during a plurality of operational modes in an autonomous vehicle according to various embodiments may include a power converter element coupled to a first battery, a second battery, and an autonomous vehicle. In various embodiments, the power converter element may receive a first power input from the first battery and may provide a first power output to the second battery and the autonomous vehicle during a first one of the plurality of operational modes. A power control element may further include a processor coupled to the power converter element. In various embodiments, the processor may be configured with processor-readable instructions to perform the operations of the method described above.

In various embodiments, a circuit for managing a high energy density battery and a high power density battery during a plurality of operational modes in an autonomous vehicle may include a power converter element, and a first current difference amplifier circuit. The first current difference amplifier may be configured to compare a first battery current signal with a maximum discharge current threshold and output a first battery current difference signal in response to the maximum discharge current threshold being exceeded. In some embodiments, the circuit for managing a high energy density battery and a high power density battery during a plurality of operational modes may further include a first voltage difference amplifier circuit that may be configured to compare a first battery voltage in the first battery with a minimum voltage threshold of the first battery and output a first battery voltage difference signal in response to the minimum voltage threshold being exceeded. In some embodiments, the circuit for managing a high energy density battery and a high power density battery during a plurality of operational modes may further include a control signal circuit configured to provide a control input to the power converter element to reduce the first power output in response to the output of one or both of the first battery current difference signal and the first battery voltage difference signal. In some embodiments, a second power output from the second battery to power the autonomous vehicle may be increased during a second one of the plurality of operational modes in response to reduction of the first power output.

In some embodiments, circuit for managing a high energy density battery and a high power density battery during a plurality of operational modes may further include a current sensing circuit that may be configured to sense a first battery current in the first battery and output the first battery current signal in response to sensing the first battery current. In some embodiments, the first battery current difference signal may be proportional to the difference between the first battery current signal and the maximum discharge current threshold. In some embodiments, the voltage difference signal may be proportional to the difference between the first battery voltage and the minimum voltage threshold.

In some embodiments, the circuit for managing a high energy density battery and a high power density battery during a plurality of operational modes may further include a second current difference amplifier circuit that may be configured to compare a second battery current signal with a maximum charge current threshold and output a second battery current difference signal in response to the maximum charge current threshold being exceeded during a third one of the plurality of operational modes in which a charging power is output to the second battery. In some embodiments, the circuit may further include a second voltage difference amplifier circuit that may be configured to compare a second battery voltage in the second battery with a maximum voltage threshold of the second battery and output a second voltage difference signal in response to the minimum voltage threshold being exceeded during the third one of the plurality of operational modes. In some embodiments, the control circuit may be configured to provide the control input to the power converter element to reduce the charging output to the second battery in response to the output of one or both of the second battery current difference signal and the second battery voltage difference signal. In some embodiments, the charging output may be applied to the first battery during the third one of the plurality of operational modes in response to the reduction of the charging output to the second battery.

In some embodiments, the power converter element may include one or both of a part-time buck converter, a buck-boost converter, a full-time boost converter; a linear current limiter; a power regulator; and a bidirectional power converter.

### BRIEF DESCRIPTION OF THE DRAWINGS

The accompanying drawings, which are incorporated herein and constitute part of this specification, illustrate exemplary embodiments of the claims, and together with the general description given above and the detailed description given below, serve to explain the features of the claims.

FIGS. 1A-FIG. 1C are diagrams illustrating components of an autonomous vehicle (autonomous vehicle) suitable for use in various embodiments.

FIG. 1D is a diagram illustrating electrical and electronic components of a typical autonomous vehicle including batteries and a power control element for use in various embodiments.

FIG. 2 is a diagram illustrating various relevant flight modes for a typical rotor wing autonomous vehicle in various embodiments.

FIG. 3A-FIG. 3E are diagrams illustrating various relative power contributions among batteries in various embodiments.

FIG. 4A-FIG. 4B are diagrams illustrating threshold and measurement inputs to a power control element in various embodiments.

FIG. 4C is a circuit diagram illustrating a power control element as a power control circuit in various embodiments.

FIG. 4D is a diagram illustrating a portion of a power control element circuit and functional blocks in various embodiments.

FIG. 5A is a process flow diagram illustrating a method for monitoring batteries and performing power control according to various embodiments.

FIG. 5B is a process flow diagram illustrating a method for applying output limiting control of a power control element according to various embodiments.

FIG. 5C is a process flow diagram further illustrating a method for applying output limiting control of a power control element according to various embodiments.

FIG. 5D is a process flow diagram illustrating a method for applying output-limiting control of a power control element during external charging according to various embodiments.

FIG. 5E is a process flow diagram illustrating a method for applying output limiting control of a power control element during regenerative charging according to various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments involve a circuit and method for controlling the output of a power control element in a battery management system of an autonomous vehicle in which at least two batteries are used. One of the batteries may be a high energy density battery (e.g., BATT1) for providing sustained levels of energy over relatively long periods of time, such as during sustained flight of the autonomous vehicle. Another of the batteries may be a high power density battery (e.g., BATT2) for providing high levels of instantaneous energy over a relatively short period of time, such as during takeoff, landing, and maneuvering of the autonomous vehicle.

In various embodiments, BATT1 (e.g., high energy density battery) may be a main battery (e.g., high energy density battery) that provides most of the energy needed for routine autonomous vehicle flight and/or loitering operations. Examples of primary battery types for BATT1 may include a lithium ion battery, an air-aluminum battery, a fuel cell, a solar cell, and a primary lithium battery. In various embodiments, BATT2 may be a secondary battery (e.g., high power density battery) that provides the peak power density needed for short duration high intensity power demand transients, such as from takeoff to an altitude of 300 meters for a fixed wing autonomous vehicle. The secondary battery BATT2 may need to supply only enough energy to make up the difference between the average demand (e.g., as supplied by the primary battery BATT1) and the peak demand during the duration of the transient. Examples of secondary battery types for BATT2 may include a double layer ultracapacitor, a lead-acid battery, and a lithium iron phosphate battery.

In various embodiments, a battery management system may enable each battery to be tailored to fulfill a particular role, such as providing sustained energy or satisfying high power demands. The output of one or more batteries may be managed by a power control element. By managing the output of a power control element to fulfill the power demands of varying flight conditions, net power and energy density of the system may be increased. Battery management through the power control element may further ensure that charging currents for the high power density battery BATT2 (e.g., from the high energy density battery BATT1) are properly controlled to reduce the possibility of battery damage, excessive heat, for one or both batteries. Discharge current for the high energy density battery must be managed to ensure maximum battery life and to reduce the possibility of battery damage, excessive heat, etc. By ensuring that the voltages and currents are controlled within the rated maximum and minimum values for each battery, potentially damaging conditions can be avoided.

In various embodiments, the power control element may be configured as a power control circuit that may monitor and adjust the output power of a power converter element, such as a linear converter, power converter, power regulator, or other power converter element. In a linear current limiter example, the two batteries BATT1 and BATT2 may be managed by limiting current (and discharge) using a linear circuit. In some embodiments, the linear circuit may be bidirectional to manage power provided to a drive motor and power provided from a generator or regenerative section of the drive motor and fed back into the battery. The primary element of a power converter element when embodied as a linear current limiter may be a power switch operated in its linear region. For example, the primary element may comprise back-to-back power FETs, operated in their linear region.

In some embodiments, a power converter may be used as the power converter element. Examples of a power converter may include a part-time buck converter, a buck-boost converter, a full-time boost converter, etc.

In a part time buck converter power converter example, the two batteries BATT1 and BATT2 may be managed by limiting current and a discharge level to at least one of the batteries using the buck converter during certain conditions (e.g., part-time). At other times, the converter operates in a no conversion (e.g., pass-through) mode. During no-conversion operation, the buck converter may be configured to be fully on at 100% duty cycle with the converter inductor element in saturation. The 100% duty cycle configuration of the buck converter may lead to a very efficient pass-through of power. When current exceeds a limit or threshold, the buck converter may limit current by reducing the duty cycle. The reduction of the duty cycle may be controlled in a closed-loop feedback system. Besides managing the power applied to the drive motor of the autonomous vehicle, the part time buck converter may be bidirectional to manage regenerated power fed back into the battery.

The thresholds and duty cycles of the buck converter may be configured based on the battery chemistries and ratings. For many lithium-ion battery chemistries, the discharge rate may be limited to 3C, which is three times the battery capacity in amp-hours. The charge rate may be limited to 1C. In various embodiments, an exemplary buck converter may limit BATT1-to-BATT2 charging current to 3C (three times the capacity of BATT1 in amp hours). The BATT2-to-BATT1 current would be limited to 1C. In some embodiments, during charging/regeneration, a charging source may treat the secondary battery (e.g., BATT2) as the only battery in the system simplifying system design.

In other embodiments, a full time buck or boost converter may be the power converter element. In some embodiments, the primary (BATT1) and secondary (BATT2) batteries can operate at different voltage levels allowing more diverse and different battery chemistries to be used. A full-time buck or boost converter may therefore operate at similar voltage levels to reduce losses. Further, the management of the batteries using the full time buck or boost converter may involve maintaining a state of charge of the batteries. The secondary battery (BATT2) may be maintained at a state of charge with power from the primary battery (BATT1). When load spikes are encountered during autonomous vehicle operation, the spikes may be allowed to be drawn from the secondary battery (BATT2). To accomplish such management, the secondary battery (BATT2) may be maintained at a high state of charge (e.g., around 80% to 100%). Optionally, the secondary battery (BATT2) may be maintained at a state of charge that enables load spikes to be sourced and regeneration spikes to be sunk or absorbed. Such an option requires maintaining the secondary battery (BATT2) at a lower state of charge that is closer to 50%.

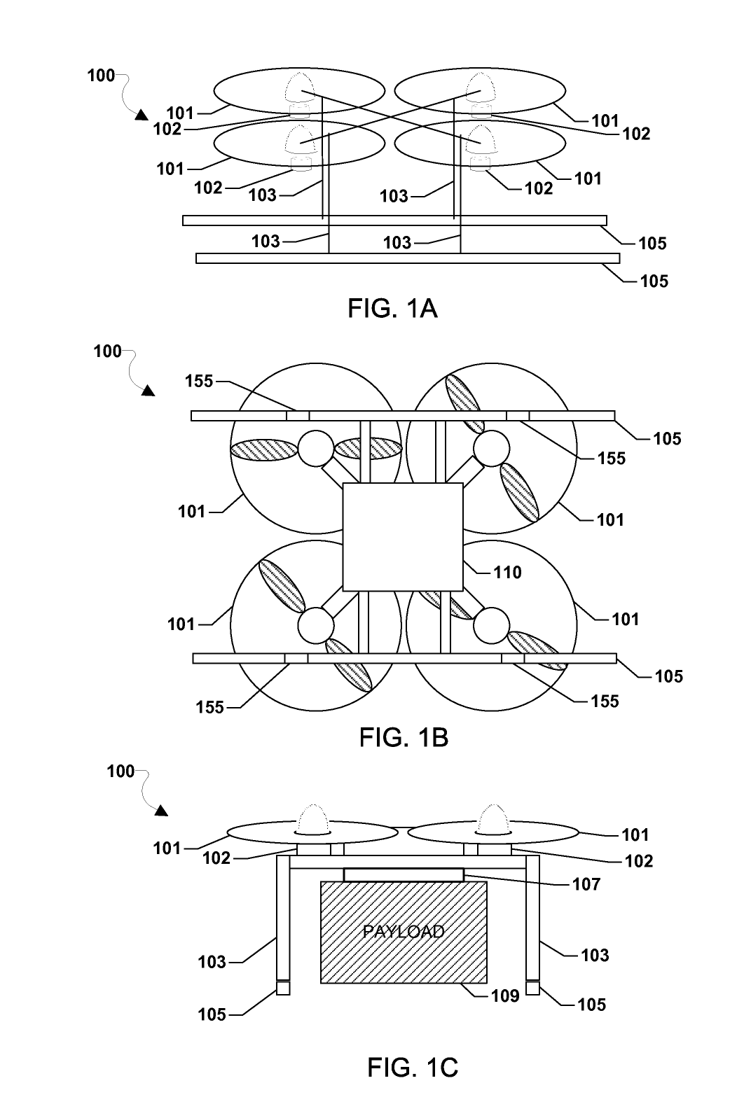

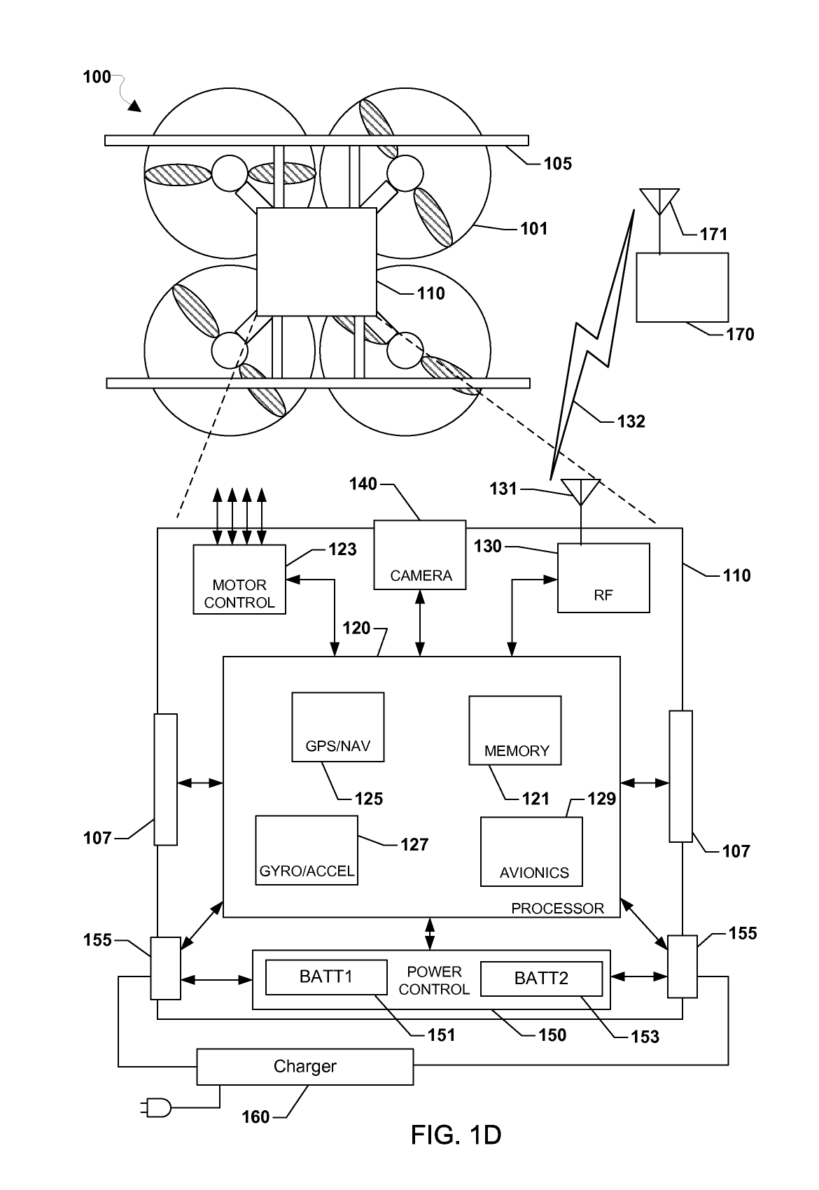

An example of an autonomous vehicle 100 is illustrated in FIGS. 1A through 1D in accordance with various embodiments. In some embodiments, the autonomous vehicle 100 may include several rotors 101, several drive motors 102, a frame 103, and landing skids 105. The frame 103 may provide structural support for the drive motors 102 associated with the rotors 101 and the landing skids 105. The structural support of the frame 103 may be sufficiently strong to support the maximum load weight for the components of the autonomous vehicle 100 and, in some cases, a package or payload 109. The structural support may further withstand additional acceleration forces (e.g., gravitational forces, g-forces, or “gees”) generated during flight and flight maneuvering, which can be substantial.

For ease of description and illustration, some detailed aspects of the autonomous vehicle 100 are omitted such as wiring, frame structure interconnects, or other features known to one of skill in the art. While the frame 103 is shown and described as having several support members or frame structures, the autonomous vehicle 100 may be constructed using a molded frame in which support is obtained through the molded structure. In some embodiments, the molded frame may be a single body frame construction. In the illustrated “quadcopter” embodiments, the autonomous vehicle 100 has four of the rotors 101. However, more or fewer than four rotors 101 may be used. Also, different physical constructions are possible that may depart partially or entirely from the “copter” configuration, while remaining consistent with various described embodiments.

In some embodiments, the autonomous vehicle 100 may be a fixed winged airplane configuration with forward, rearward, and/or wing mounted, front/rear/variable facing propulsion units. Further, the autonomous vehicle 100 may be configured for different missions other than or in addition to package delivery as described. For example, the autonomous vehicle 100 may be equipped for weather sounding, video surveillance and image capture, agricultural spraying, or other missions. The autonomous vehicle 100 may proceed in autonomous flight or may be controlled in piloted flight or some combination of autonomous and piloted flight.

In some embodiments, the landing skids 105 of the autonomous vehicle 100 may be provided with landing sensors. The landing sensors 155 may be optical sensors, radio sensors, camera sensors, or other sensors. Alternatively or additionally, the landing sensors 155 may be contact or pressure sensors that may provide a signal that indicates when the autonomous vehicle 100 has made contact with a surface. In some embodiments, the landing sensors 155 may be adapted to provide the additional ability to couple to a docking station or a charger 160. The charger 160 may be configured to charge a battery or batteries (e.g., a BATT1 151 and a BATT2 153 through a power control module 150) of the autonomous vehicle 100 when the autonomous vehicle 100 is positioned on a suitable landing pad, such as through charging connectors. In some embodiments, the landing sensors 155 may provide additional connections with a landing pad, such as wired communication or control connections for uploading/downloading flight commands/information or other information.

In some embodiments, the autonomous vehicle 100 may further have a payload-securing unit 107. The payload-securing unit 107 may include an actuator motor (not shown) that drives a gripping and release mechanism and related controls that are responsive to the control unit 110 to grip and release a payload 109 in response to commands from the control unit 110. While the payload-securing unit 107 may grip and release the payload 109 in package delivery mission embodiments, other additional or alternative mechanisms may be present depending on the particular mission of the autonomous vehicle 100.

The autonomous vehicle 100 may further include a control unit 110 that may house various circuits and devices used to control the operation of the autonomous vehicle 100, such as subsystems of the autonomous vehicle 100 including the drive motors 102 for powering the rotors 101, the BATT1 151, the BATT2 153, a communication module, and so on. The control unit 110 may include a processor 120, a radio module 130, a camera 140, and a power control module 150.

The processor 120 may include or be coupled to a memory unit 121 and a navigation unit 125. The processor 120 may be configured with processor-executable instructions to control flight and other operations the autonomous vehicle 100, including operations of various embodiments. The processor 120 may be configured to conduct autonomous flight of the autonomous vehicle 100. In some embodiments, the processor 120 may be configured to enable or facilitate the piloted flight of the autonomous vehicle 100. For example, the processor 120 may be configured to receive flight commands and provide flight control feedback and/or status. In package delivery mission embodiments, the processor 120 may be coupled to the payload-securing unit 107 and/or the landing sensors 155. In such embodiments, the landing sensors 155 may indicate when the autonomous vehicle 100 has landed, the payload-securing unit 107 can be activated, and the payload 109 can be released.

The processor 120 may be powered from a power control module 150. In addition to supplying power to the processor 120, the power control module 150 may control power supply elements such as the BATT1 151 and the BATT2 153, such as for delivering power to the drive motors 102 during flight operations. The processor 120 may be configured with processor-executable instructions to control the charging/discharging of the BATT1 151 and BATT2 153 to deliver power to the drive motors 102, such as by executing a charging/discharging control algorithm using a charge/discharge control circuit. Some or all of the elements of the power control module 150 may be configured as a circuit to manage power delivery to the drive motors 102. For example, in some embodiments, the processor 120 may be coupled to a motor control unit 123 configured to manage the drive motors 102 that drive the rotors 101.

Through control of individual ones of the drive motors 102 of the rotors 101, the autonomous vehicle 100 may be controlled in flight (e.g., autonomously or pilot controlled) as the autonomous vehicle 100 progresses toward a destination or otherwise travels. The autonomous vehicle 100 may be controlled in various flight modes that require various power levels depending on the flight operation, the length of flight, the flight maneuvers, etc. The processor 120 may receive data associated with the flight from the navigation unit 125. The processor 120 may use the flight data to determine the present position and orientation of the autonomous vehicle 100, and the course towards the destination. In some embodiments, the navigation unit 125 may include a Global Navigation Satellite System (GNSS) receiver system (e.g., one or more Global Positioning System (GPS) receivers) enabling the autonomous vehicle 100 to navigate using GNSS signals.

Alternatively or in addition, the navigation unit 125 may have radio navigation receivers for receiving navigation beacon or other signals from radio nodes, such as navigation beacons (e.g., very-high frequency (VHF) omnidirectional range (VOR) beacons), Wi-Fi access points, cellular network sites, radio station, etc. Additionally, the processor 120 and/or the navigation unit 125 may be configured to communicate with a server through a wireless connection (e.g., a cellular data network) to receive data useful in navigation and provide real-time position reports.

An avionics module 129 coupled to the processor 120 and/or the navigation unit 125 may be configured to provide flight control-related information such as altitude, attitude, airspeed, heading and similar information that the navigation unit 125 may use for navigation, such as dead reckoning between GNSS position updates. The avionics module 129 may include or receive data from a gyro/accelerometer unit 127 that provides data regarding the orientation and accelerations of the autonomous vehicle 100 that may be used in navigation calculations. The flight control-related information may be relayed to a pilot station during piloted flight.

The radio module 130 (also referred to as a “radio frequency (RF) module”) may be configured to receive (e.g., via antenna 131) navigation signals, such as beacon signals from restricted areas, signals from aviation navigation facilities, etc., and provide such signals to the processor 120 and/or the navigation unit 125 to assist in autonomous vehicle navigation. In some embodiments, the navigation unit 125 may use signals received from recognizable RF emitters (e.g., AM/FM radio stations, Wi-Fi access points, cellular network base stations, etc.) remote from the autonomous vehicle 100. The locations, unique identifiers, single strengths, frequencies, and other characteristic information of such RF emitters may be stored in a database and used to determine position (e.g., via triangulation and/or trilateration) when RF signals are received by the radio module 130. Such a database of RF emitters may be stored in the memory unit 121 of the autonomous vehicle 100, in a ground-based server in communication with the processor 120 via a wireless communication link, or in a combination of the memory unit 121 and a ground-based server.

Navigating using information about RF emitters may use any of several conventional methods. Upon receiving an RF signal via the radio module 130, the processor 120 may obtain the signal's unique identifier (e.g., a service sector identification (SSID), a media access control (MAC) address, radio station call sign, cell ID, etc.), and use that information to obtain the ground coordinates and signal strength of the detected RF emitter from the database of RF emitter characteristics. If the database is stored in onboard memory such as the memory unit 121, the processor 120 may use the emitter identifier information to perform a table look up in the database. In some embodiments, the processor 120 may use the radio module 130 to transmit the detected RF emitter identifier to a Location Information Service (LIS) server, which may return a location of the RF emitter obtained an RF emitter location database. Using the RF emitters coordinates and optionally the signal strength characteristics, the processor 120 (or the navigation unit 125) may estimate the location of the autonomous vehicle 100 relative to those coordinates. Using locations of three or more RF emitters detected by the radio module 130, the processor may determine a more precise location via trilateration. Estimates of location based on received ground-based RF emitters may be combined with position information from a GNSS receiver to provide more precise and reliable location estimates than achievable with either method alone.

The processor 120 may use the radio module 130 to conduct wireless communications with a variety of wireless communication devices 170 such as a beacon, a server, smartphone, tablet, or other remote device with which the autonomous vehicle 100 may be in communication. In various embodiments, the processor 120 may establish communication with a control system, such as a gateway/server/central node to facilitate operations, including the offering of missions to pilots and the relay of commands and control feedback once a pilot is selected. A bi-directional wireless communication link 132 may be established between transmit/receive antenna 131 of the radio module 130 and transmit/receive antenna 171 of the wireless communication device 170. In some embodiments, the wireless communication device 170 may be an access node for a control system as described.

In some embodiments, the wireless communication device 170 may be a pilot station for controlling the autonomous vehicle 100 in piloted flight. In some embodiments, the wireless communication device 170 may be a cellular network base station or cell tower that provides a direct or indirect connection to a control system and/or a pilot station. The radio module 130 may be configured to support multiple connections with different wireless communication devices 170 having different radio access technologies.

In some embodiments, the wireless communication device 170 may be connected to a server or provides access to a server. In some embodiments, the wireless communication device 170 may be a server of an autonomous vehicle operator, a server of a control system operator, a third party service (e.g., package delivery, billing, etc.), or a pilot station. The autonomous vehicle 100 may communicate with a server through an intermediate communication link such as one or more network nodes or other communication devices.

In some embodiments, the radio module 130 may be configured to switch between a wireless wide area network connection and a Wi-Fi connection depending on the location and altitude of the autonomous vehicle 100. While in flight at an altitude designated for autonomous vehicle traffic, the radio module 130 may communicate with a cellular infrastructure to maintain communications with a control system or server. An example of a flight altitude for the autonomous vehicle 100 may be at around 400 feet or less, such as may be designated by a government authority (e.g., FAA) for autonomous vehicle flight traffic. At this altitude, it may be difficult to establish communication with some of the wireless communication devices 170 using short-range radio communication links (e.g., Wi-Fi). Therefore, communications with other wireless communication devices 170 may be established using cellular telephone networks (or other suitable communication networks, such as satellite communication networks) while the autonomous vehicle 100 is at flight altitude. Communication between the radio module 130 and the wireless communication device 170 may transition to a short-range communication link (e.g., Wi-Fi, Bluetooth, and/or the like) when the autonomous vehicle 100 moves closer to the wireless communication device 170.

In some embodiments, the wireless communication device 170 may be associated with an area in which autonomous vehicle operations are prohibited or restricted, referred to as a “restricted area.” The wireless communication device 170 may be a beacon device that emits a navigation signal identifying or indicating the restricted area. As another example, the wireless communication device 170 may be wireless access point or cellular network base station coupled to a server associated with the restricted area. The server may use the wireless communication device 170 to communicate with the autonomous vehicle 100 when the autonomous vehicle 100 is in or near the restricted area, or send coordinates of the restricted area to the autonomous vehicle 100 through a data connection established with the autonomous vehicle 100 (e.g., through a cellular data connection maintained by the autonomous vehicle 100 with a cellular network). In such cases, the presence of the autonomous vehicle 100 in a restricted area or required flight through the restricted area may be included as one of the conditions for which piloted flight is necessitated. The operator of the autonomous vehicle 100 may decide that the conditions of the restricted area, such as an airport with active flight operations, may necessitate a pilot for the autonomous vehicle 100. In other examples, the operator of the restricted area may, as a condition of entry into the restricted area, require piloted flight for the autonomous vehicle 100.

In some embodiments, the wireless communication device 170 may also be a server associated with the operator of the autonomous vehicle 100, which communicates with the autonomous vehicle 100, directly, through a local access node or through a data connection maintained through a cellular connection.

While the components of the control unit 110 are illustrated in FIG. 1D as separate components, some or all of the components (e.g., the processor 120, the motor control unit 123, the radio module 130, and other units) may be integrated together in a single device or module, such as a system-on-chip module.

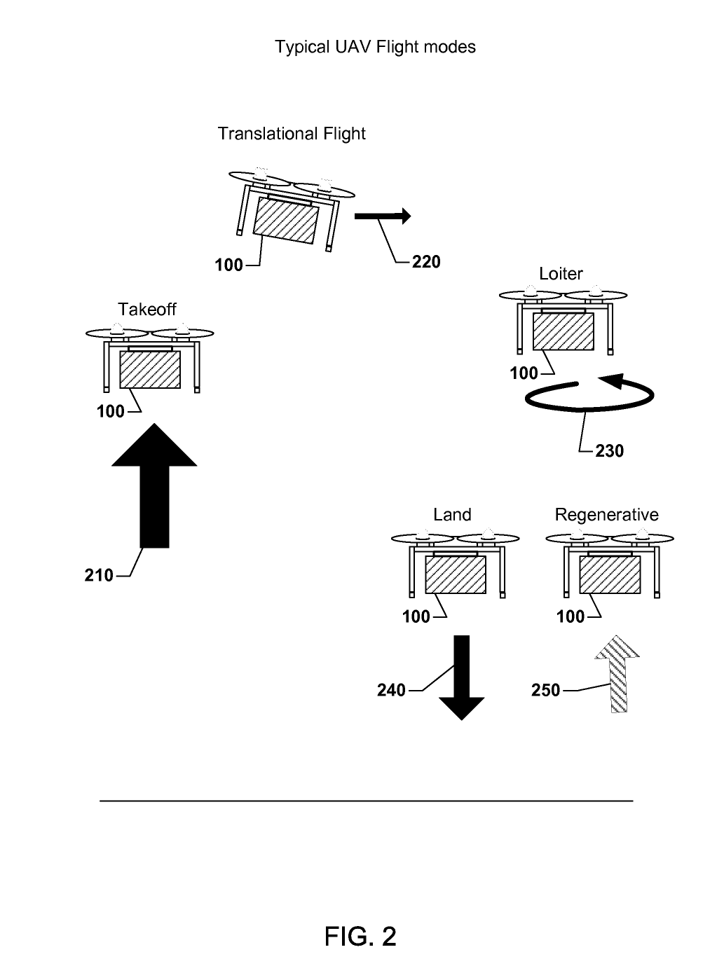

As illustrated in FIG. 2 an autonomous vehicle (e.g., 100 in FIGS. 1A-1D) may engage in several different flight modes in various embodiments. The flight modes illustrated in FIG. 2 may represent at least some of the flight modes associated with operational flight of the autonomous vehicle 100 or other autonomous vehicle. Other flight modes not illustrated may exist. Combinations of the illustrated flight modes may also exist. Further, while various flight modes are illustrated, a given operational mission of the autonomous vehicle 100 may use all the illustrated flight modes or may use flight modes not illustrated. Further, a mission of the autonomous vehicle 100 may involve linked maneuvers including one or more of the illustrated flight modes and/or other modes. The autonomous vehicle 100 may have a flight mode that requires a specific (instantaneous) power level to sustain, while also having a total power requirement throughout the duration of the mission.

With reference to FIGS. 1A-2, the drive motors 102 of the autonomous vehicle 100 may drive the rotors 101 to attain the flight modes. Depending on the flight mode of the autonomous vehicle 100, different power requirements may arise for powering the drive motors 102 for the required flight modes. During a takeoff operation (or a rapid climb operation), the autonomous vehicle 100 may require a takeoff power demand level 210. The autonomous vehicle 100 may engage in translational flight, which may involve moving laterally with minimal climb or descent components. The translational flight of the autonomous vehicle 100 may require a translational power demand level 220. The autonomous vehicle 100 may further engage in loitering flight, which may involve hovering, moving laterally and/or circularly within the same area with some minimal and/or slowly applied changes in altitude. The loitering flight of the autonomous vehicle 100 may require a loitering power demand level 230. The autonomous vehicle 100 may engage in landing flight (or rapid descent), which involves reducing altitude while controlling the autonomous vehicle 100 such that destructive contact with landing surfaces such as the ground does not occur.

In some embodiments, landing flight may involve rapid descent coupled with power reversal when close to the ground. The landing flight of the autonomous vehicle 100 may require a landing power demand level 240. In some embodiments, such as during landing or descent modes, one or more of the motors 102 of the autonomous vehicle 100 may be configured to regenerate power. The regenerative flight of the autonomous vehicle 100 may provide a regenerative power level 250.

The takeoff power demand level 210 may be the highest instantaneous power level demanded by the autonomous vehicle 100. The takeoff power demand level 210 may exceed the instantaneous power delivery capability of the high energy density main battery, such as the BATT1 151. To meet the takeoff power demand level 210, power delivery from the high power density secondary battery, such as the BATT2 153 may be required. The remaining flight modes 220, 230, 240 may generally require less power than the takeoff power demand level 210. For example, the translational power demand level 220 may generally be the lowest power level demanded by the autonomous vehicle 100. The loitering power demand level 230 may generally be the next lowest power level demanded by the autonomous vehicle 100. The landing power demand level 240 may generally be the second highest power level demanded by the autonomous vehicle 100. However, a given flight mission of the autonomous vehicle 100 may involve a series of these maneuvers. Therefore, a flight mission of the autonomous vehicle 100 may require a particular instantaneous power demand level relatively high or low depending on the maneuver being undertaken (e.g., high/low power density requirement). Further, throughout the duration of a flight mission of the autonomous vehicle 100, a particular total energy may be required (e.g., total energy density requirement). The total energy requirement may be the sum of the energy demand levels for different maneuvers conducted during the flight mission of the autonomous vehicle 100.

Various embodiments enable the monitoring of charge/discharge currents and voltage levels associated with BATT1 and BATT2. The monitored levels may control the output of a power control element that ensures that power demand levels (e.g., high instantaneous power demand, high total energy demand) can be met for the autonomous vehicle 100.

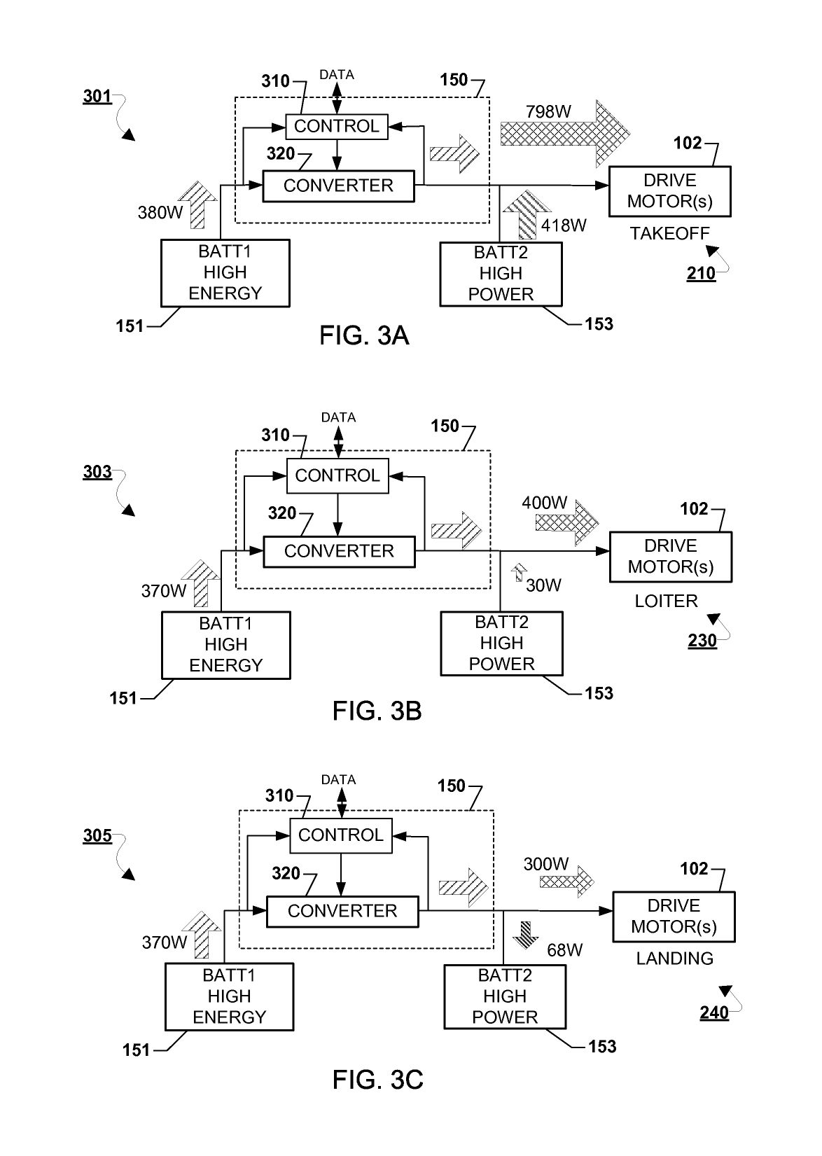

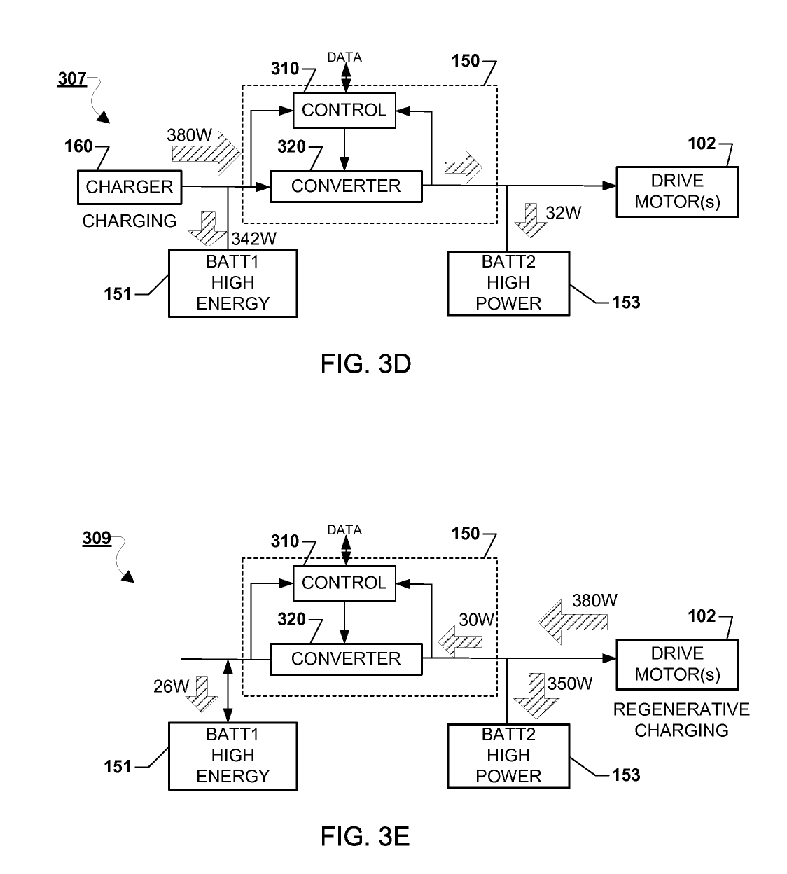

In various embodiments, illustrated in FIGS. 3A-3E, an autonomous vehicle may proceed in a flight operation that involves various power demands associated with various flight modes or operational modes, such as operational modes 301, 303, 305, 307 and 309. With reference to FIGS. 1A-3E, the autonomous vehicle 100 (e.g., autonomous vehicle 100) the operational modes 301, 303, 305, 307, and 309 may include various flight modes, external charging modes, regenerative charging modes, etc. The operational modes 301, 303, 305, 307, and 309 are illustrated for a point in time during each operational mode. The operational modes 301, 303, 305, 307, and 309 are illustrated with representative values for corresponding power demands and contributions of power from the BATT1 151 and the BATT2 153, power regenerator, charger, etc.

In some embodiments, the operational mode 301 for the autonomous vehicle 100 may be a takeoff mode. The operational mode 301 may be associated with a takeoff power demand level of the drive motor(s) 102, such as the takeoff power demand level 210 as described. In the operational mode 301, the power control module 150, which may include a power control element 310 and a power converter element 320, may pass power through from the high-energy battery the BATT1 151 to supply power to the drive motor 102.

During the operational mode 301, the BATT1 151 may supply approximately 380 W of power to the power control module 150 (e.g., approximately 380 W of power is drawn from the BATT1 151). The voltage and current levels associated with the BATT1 151 may be supplied to the power control element 310. In other words, the power control element 310 may monitor the voltage and current levels associated with the BATT1 151. In some embodiments, data may be supplied to the power control element 310, such as threshold values for the monitored voltages and currents over a data line. The power control element 310 may also provide data to other devices such as another processor or controller (not shown) through the data line.

The power from the BATT1 151 may be supplied to the power converter element 320. The power converter element 320 may be a part-time converter that may supply full power from the BATT1 151 to the drive motor 102, provided that the discharge current does not exceed a threshold and the voltage does not drop below a threshold. When the current or voltage levels exceed (above or below) a threshold, the power control element may operate. In other embodiments, the power control element 310 may be a full time converter that may operate throughout the range of monitored currents and voltages. Based on current and voltage levels monitored by the power control element 310, the power converter element 320 may be controlled to reduce the output to the drive motor 102. By reducing the output of the power converter element 320, the BATT1 151 may be protected from an over current scenario indicated by an excessive current or a low voltage condition of the BATT1 151.

Also during the operational mode 301, the BATT2 153 may provide approximately 418 W of additional power to the drive motor 102 to meet the takeoff power demand level 210. The voltage and current levels for the BATT2 153 may also be provided to the power control element 310 for monitoring. As illustrated, during the operational mode 301 (e.g., takeoff mode), the BATT2 153 may provide a significant contribution (e.g., more than that provided by the BATT1 151) to the takeoff power demand level 210 of the drive motor 102. The total power provided by the BATT1 151 and the BATT2 153 may be approximately 798 W at least during an instant in time represented by the operational mode 301. Although in some embodiments, the BATT2 153 may contribute more power to the takeoff power demand level 210 than the BATT1 151, in other embodiments, the BATT2 153 may contribute less power (but still a relatively high amount of power) to the takeoff power demand level 210 than the BATT1 151.

In some embodiments, the operational mode 303 for the autonomous vehicle 100 may be a loiter mode. The operational mode 303 may be associated with a loitering power demand level of the drive motor(s) 102, such as the loitering power demand level 230 as described. In some embodiments, the loiter mode and the translational mode may have similar power demand levels and the translational mode is omitted for brevity. In the operational mode 303, the power control module 150 may pass power through from the high-energy battery, the BATT1 151 to supply power to the drive motor 102.

During the operational mode 303, the BATT1 151 may supply approximately 370 W of power to the power control module 150 (e.g., approximately 370 W of power is drawn from BATT1 151). The voltage and current levels associated with the BATT1 151 may be supplied to the power control element 310 such that the voltage and current levels associated with the BATT1 151 may be monitored. The power from the BATT1 151 may be supplied to the power converter element 320. The power converter element 320 may be a part-time or full time converter that may supply full power from the BATT1 151 to the drive motor 102 or a reduced output depending on the levels of the monitored voltages and currents. Based on current and voltage levels monitored by the power control element 310, the output of the power converter element 320 may be controlled to protect the BATT1 151 and the BATT2 153 from voltage/current scenarios that may be damaging.

Also during the operational mode 303, the BATT2 153 may provide approximately 30 W of additional power to the drive motor 102 to meet the loitering power demand level 230, which is relatively low compared to the takeoff power demand level 210. As illustrated, the BATT2 153 may provide a small contribution to the loitering power demand level 230 of the drive motor 102 during the loiter mode. The total power provided by the BATT1 151 and the BATT2 153 may be approximately 400 W. In some embodiments, BATT2 153 need not contribute any power to the loitering power demand level 230 of the drive motor 102 during the loiter mode.

In some embodiments, the operational mode 305 for the autonomous vehicle 100 may be a landing mode. The operational mode 305 may be associated with a landing power demand level of the drive motor(s) 102, such as the landing power demand level 240 as described. In the operational mode 305, the power control module 150 may pass power through from the BATT1 151 to supply power to the drive motor 102. Further, in some embodiments, since descent may not consume significant power, the power control module 150 may be configured to use a portion of the power supplied by the BATT1 151 to charge the BATT2 153.

During the operational mode 305, the BATT1 151 may supply approximately 370 W of power to the power control module 150 (e.g., approximately 370 W of power is drawn from BATT1 151). The voltage and current levels associated with the BATT1 151 may be supplied to the power control element 310 such that the voltage and current levels associated with the BATT1 151 may be monitored. The power from the BATT1 151 may be supplied to the power converter element 320. The power converter element 320 may be a part-time or full time converter that may supply full power from the BATT1 151 to the drive motor 102 or a reduced output depending on the levels of the monitored voltages and currents. Based on current and voltage levels monitored by the power control element 310, the output of the power converter element 320 may be controlled to protect the BATT1 151 and the BATT2 153 from voltage/current scenarios that may be damaging.

Also during the operational mode 305, the power requirement for the drive motor 102 may be less than the output of BATT1 151. The power control module 150 may sense the difference in the power requirement of the drive motor 102 and the output capacity of the BATT2 153 and may be configured to provide approximately 300 W of power to the drive motor 102 to meet the landing power demand level 240. The excess power may enable 68 W of charging power to be provided to the BATT2 153. As illustrated, in some embodiments, the BATT2 153 may provide no contribution to the landing power demand level 240 of the drive motor 102 during the landing mode. The total power provided by the BATT1 151 and absorbed by the motor 102 and the BATT2 153 may be approximately 368 W.

In some embodiments, the operational mode 307 for the autonomous vehicle 100 may be an external charging mode. The charging may be provided by a stationary charger or external charger, such as the charger 160. In some embodiments, regenerative charging may be provided in place of the charger 160, such as on the input side of the power converter element 320. In the operational mode 307, the power control module 150 may provide charging current to the BATT1 151. The power control module 150 may further pass charging current to the BATT2 153. Depending on the rates of charge and ratings of the BATT1 151 and the BATT2 153, the power control module 150 may control the output of the power converter element 320 to reduce the output to BATT2 153, or conversely divert current from BATT1 151 to BATT2 153.

During the operational mode 307, the charger 160 may supply a total output of approximately 380 W of power. The operational mode 307 illustrates a point in time toward the end of charging. From the output of the charger 160, approximately 342 W of power may be supplied for charging the BATT1 151. The remaining output of the charger 160 (e.g., approximately 32 W) may be passed through the power control module 150 to charge the BATT2 153. The voltage and current levels associated with charging of the BATT1 151 and the BATT2 153 may be supplied to the power control element 310. The voltage and current levels associated with charging of the BATT1 151 and the BATT2 153 may be monitored by the power control element 310. Because the power control element 310 is configured to monitor BATT1 151 for discharge, the power control element 310 will not limit the current output to BATT1 151 during charging, other than by diverting some of the charge current to BATT2 153. The charging current and voltage associated with the BATT1 151 may be practically unlimited or may be expected to remain within current and voltage thresholds during charging.

In some embodiments, the power control element 310 and the power converter element 320 may operate as if the BATT2 153 was the only battery in the system. As a result, current limiting based on measured current and voltage parameters of the BATT1 151 may be minimal. At least initially, a large proportion of the output of the charger 160 may be passed through the power converter element 320 to charge the BATT2 153. As the BATT2 153 approaches its maximum charge voltage levels, the power output of the power converter element 320 may be reduced enabling more of the output of the charger 160 to be applied to the BATT1 151. As in other examples, the output of the power converter may be controlled to protect the BATT1 151 and the BATT2 153 from voltage/current scenarios during charging that may be damaging, to provide an efficient allocation of charging current, etc.

In some embodiments, the operational mode 309 for the autonomous vehicle 100 may be a regenerative charging mode. The charging may be conducted in flight, such as during a descent or a period where the operation of the drive motor 102 may be reversed into a generator mode, such as a regenerative braking mode. The regenerative charging mode may include a mode whereby rather than being driven by a drive motor, a propeller may be driven by downward motion of the autonomous vehicle 100 to activate a regenerative element (not shown), such as by rotating a generator element. In the operational mode 309, a regenerative element (not shown) associated with the drive motor 102 may, at least initially, provide charging current to the BATT2 153. Regenerative power may be provided in a reverse direction through the power control module 150 to provide charging current to the BATT1 151. Depending on the rates of charge and ratings of the BATT1 151 and the BATT2 153, the power control module 150 may control the output of the power converter element 320 to increase the output to the BATT1 151 (e.g., when the BATT2 153 is fully charged). In a regenerative mode, the power control module 150 may initially control the output of the power converter element 320 in the opposite direction to reduce the output to the BATT1 151 (e.g., from the regenerative output of the drive motor 102) until the BATT2 153 is fully charged.

During regenerative charging associated with the operational mode 309, the regenerative output may supply a total output of approximately 380 W of power. The operational mode 309 illustrates a point in time toward the beginning of regenerative charging. From the output of the regenerative element (not shown) of the drive motor 102, approximately 350 W of power may be supplied for charging the BATT2 153. The remaining output (e.g., approximately 30 W) may be passed through the power control module 150 to charge the BATT1 151. The voltage and current levels associated with charging of the BATT1 151 and the BATT2 153 may be supplied to the power control element 310. The voltage and current levels associated with charging of the BATT1 151 and the BATT2 153 may be monitored by the power control element 310. Because the power control element 310 is configured to monitor BATT1 151 for discharge, the power control element 310 may not limit the current output to BATT1 151. The charging current and voltage associated with the BATT1 151 may be unlimited or at least be expected to remain within the current and voltage thresholds during charging.

In some embodiments, such as during regenerative charging, the power control element 310 and the power converter element 320 may also operate as if BATT2 153 was the only battery in the system. Current limiting based on measured current and voltage parameters of the BATT1 151 may be minimal. At least initially, a large proportion of the output of the regenerative element of the drive motor 102 may directly charge the BATT2 153. As the BATT2 153 approaches its maximum charge voltage levels and/or maximum charge current levels, the power output of the power converter element 320 in a reversed mode may be increased enabling more of the regenerative charging output to be applied to the BATT1 151. As in other examples, the output of the power converter element 320 may be controlled to protect the BATT1 151 and the BATT2 153 from voltage/current scenarios during charging that may be damaging, to provide an efficient allocation of charging current, etc. In some embodiments, the power control module 150 may be configured such that regenerative output may be input on the same “side” of the power converter element 320 as the BATT1 153, such as at the point where the charger 160 would ordinarily be connected. In such a scenario, the regenerative output would be applied in a similar manner as the output from the charger 160.

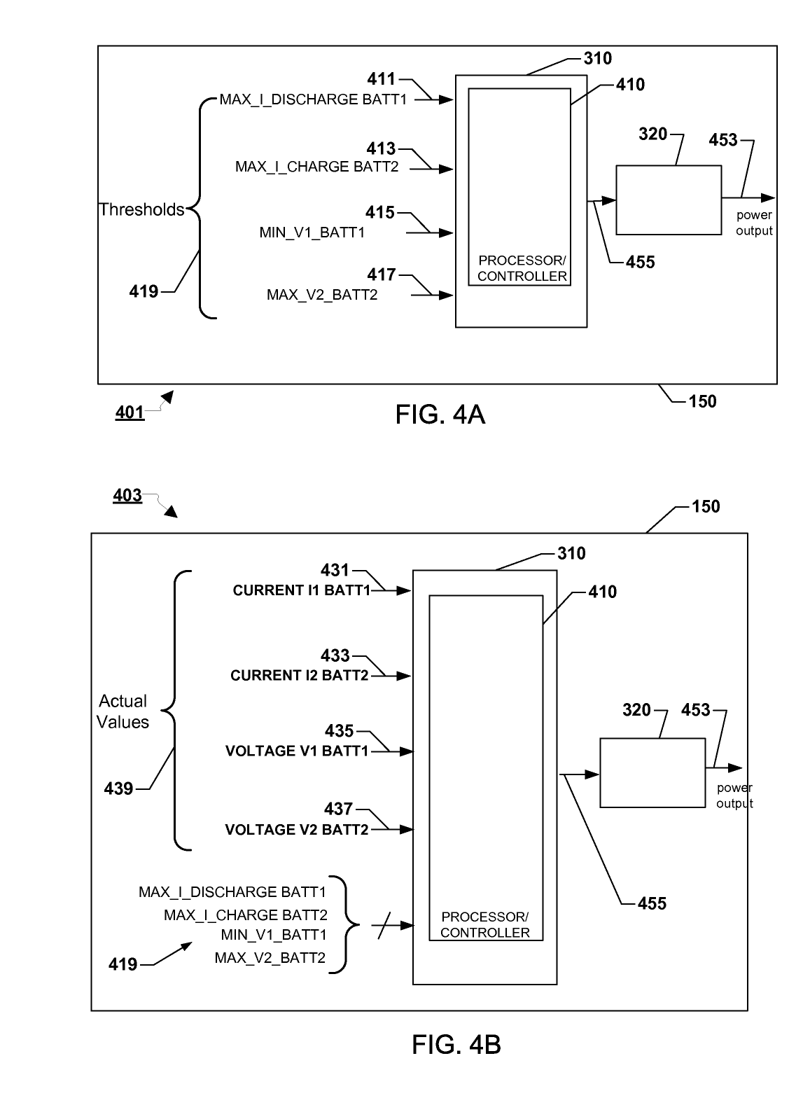

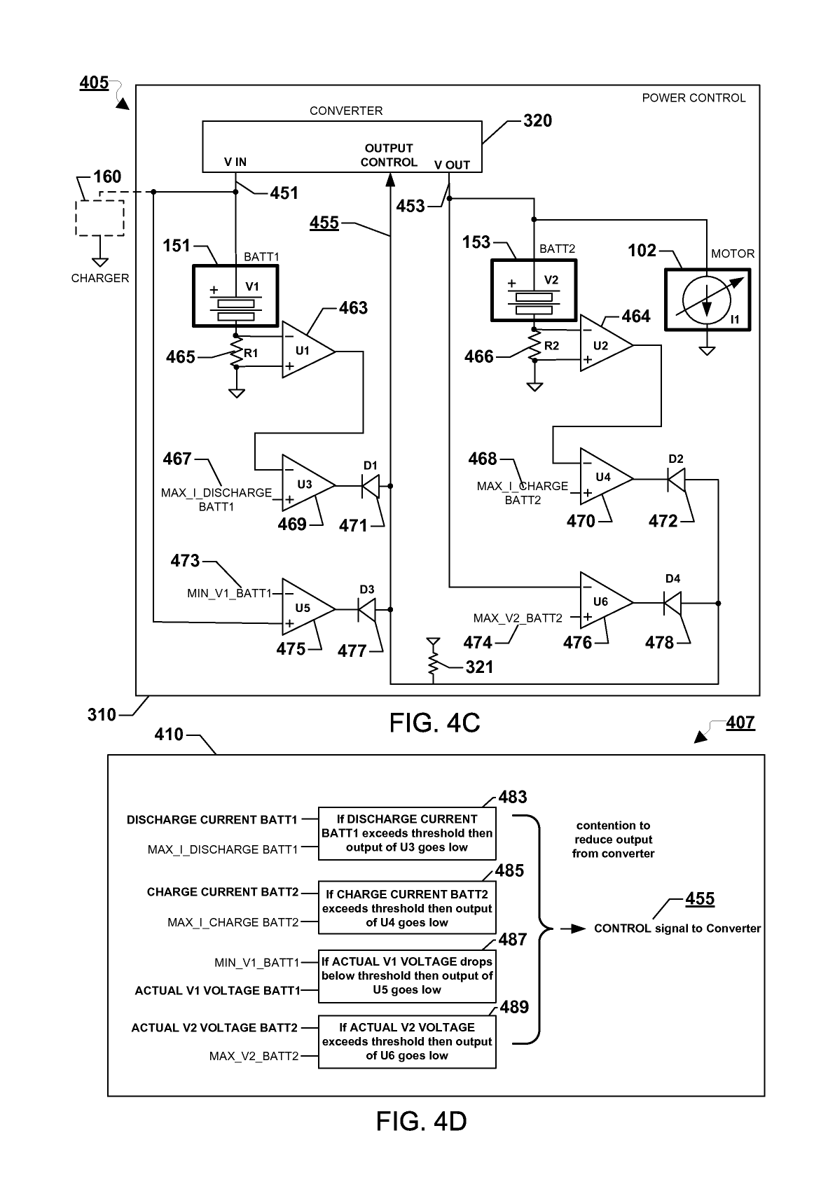

In various embodiments, illustrated in FIGS. 4A-4D, the power control module 150 may be configured in many ways. With reference to FIGS. 1A-4D, the power control module 150 may be configured to receive information such as current and voltage threshold information for the BATT1 151 and the BATT2 153. The power control module 150 may further be configured to receive actual voltage and current measurements associated with the BATT1 151 and the BATT2 153.

In some embodiments, such as in an example arrangement 401, the power control module 150 may include a power control element having a processor or controller. The power control module 150 may include the power control element 310 including a processor 410, which may be a processor, controller, or similar logic element (e.g., ASIC, PLA, PGA, etc.), and the power converter element 320. The power control element 310 may be configured to receive information, such as thresholds 419. The power control element 310 may provide a control signal 455 to the power converter element 320 that controls the output of the power converter element 320. The control signal 455 may cause the power converter element 320 to limit its current output or power output and provide a power limited output, such as a V_{OUT} 453. The V_{OUT} 453 of the power converter element 320 may be based on a comparison of actual values of the current and voltage parameters with the thresholds 419.

In various embodiments, the thresholds 419 may be received from an internal or external memory (not shown), another processor or controller, circuit, register, or other source. The thresholds 419 may include a MAX_I_DISCHARGE BATT1 threshold 411, which may represent a maximum discharge current for the BATT1 151. The thresholds 419 may further include a MAX_I_CHARGE BATT2 threshold 413, which may represent a maximum charge current for the BATT2 153. The thresholds 419 may further include a MIN_V1_BATT1 threshold 415, which may represent a minimum voltage level for the BATT1 151. In some embodiments, the MIN_V1_BATT1 threshold 415 may represent the minimum voltage for BATT1 151 during discharging. Discharging may refer to decreasing the state of charge of a battery, such as by supplying power to a load. The thresholds 419 may further include a MAX_V2_BATT2 threshold 417, which may represent a maximum voltage level for the BATT2 153. In some embodiments, the MAX_V2_BATT2 threshold 417 may represent the maximum voltage for BATT2 153 during charging. Charging may refer to increasing the state of charge of a battery, such as by receiving power from a source or supply.

In some embodiments, the processor 410 of the power control element 310 may receive and store the thresholds 419. Alternatively or additionally, the thresholds 419 may be provided to the processor 410 of the power control element 310 on input lines that may be sampled. In still other embodiments, the thresholds 419 may be software values (e.g., constants) that are pre-programmed or that can be at least periodically varied as required. The thresholds 419 may be periodically updated whether received from external inputs or generated internally by the processor 410 or other circuitry of the power control element 310 as the threshold requirements change.

In some embodiments, such as in an example arrangement 403, the power control element may receive actual values of voltage and current as inputs. The power control element 310 may receive actual values 439 of the voltage and current levels associated with the BATT1 151 and the BATT2 153, such as during operation of the autonomous vehicle 100. The actual values 439 may include a CURRENT I1 BATT1 value 431, which may represent the current associated with the BATT1 151. In some embodiments, the CURRENT I1 BATT1 value 431 may represent a discharge current in the BATT1 151. In some embodiments, the CURRENT I1 BATT1 value 431 may represent a charge current value in the BATT1 151.

The actual values 439 may further include a CURRENT 12 BATT2 value 433, which may represent the current associated with the BATT2 153. In some embodiments, the CURRENT 12 BATT2 value 433 may represent a discharge current of the BATT2 153. In other embodiments, the CURRENT 12 BATT2 value 433 may represent a charge current value of the BATT2 153. The actual values 439 may further include a VOLTAGE V1 BATT1 value 435, which may represent the voltage associated with the BATT1 151. The actual values 439 may further include a VOLTAGE V2 BATT2 value 437, which may represent the voltage associated with the BATT2 153. The actual values 439 may be analog voltage and current values measured by a suitable sensor, such as by a measurement circuit (not shown). In some embodiments, the actual values 439 may be digital values. The actual values 439 may represent analog values converted into digital values corresponding to the analog measurements values of the measured current and/or voltage values.

In various embodiments, the processor 410 of the power control element 310 may compare the actual values 439 with the thresholds 419 to generate a potentially output limiting signal, such as the control signal 455. As discussed, the control signal 455 may be input to the power converter element 320 and may generate the V_{OUT} 453. The processor 410 of the power control element 310 may compare one or more of the individual ones of the actual values 439 (e.g., the CURRENT I1 BATT1 value 431, the CURRENT 12 BATT2 value 433, the VOLTAGE V1 BATT1 value 435, and the VOLTAGE V2 BATT2 value 437) with the corresponding individual ones of the thresholds 419 (e.g., the MAX_I_DISCHARGE BATT1 threshold 411, the MAX_I_CHARGE BATT2 threshold 413, the MIN_V1_BATT1 threshold 415, and the MAX_V2_BATT2 threshold 417) to make a determination as to generating the control signal 455 to the power converter element 320. In response, the power converter element 320 may generate an output, such as the V_{OUT} 453, to drive a load (e.g., autonomous vehicle drive motor, battery or batteries, etc.).

In some embodiments, such as when none of the actual values 439 are violating the corresponding ones of the thresholds 419, the V_{OUT} 453 will not be limited. The power converter element 320 may not apply power limiting at all times. However, the power output of the power converter element 320 may be limited by power level of the input, which may originate from a battery at less than a full state of charge. Alternatively or additionally, the power output of the power converter element 320 may be limited by the power level of a charger, etc.

In some embodiments, the control signal 455 may be a control signal, such as a signal having a varying level. In such an example, the level of the signal may represent the difference between the actual and threshold values. The control signal 455 may control an element of the power converter element 320. In embodiments where the control signal 455 is a varying signal level indicative of a control quantity, the power converter element 320 may respond to the signal level by varying the power output. The power element of the power converter element 320 may provide more or less power output based on the signal level of the control signal 455. The variations in power output of the power converter element 320 may determine how much power output is provided to the batteries and the drive motor and/or other systems of the autonomous vehicle 100.

In some embodiments, the control signal 455 may be a modulated digital signal. The digital signal may be a pulse width modulated (PWM) signal that is input to a switching converter that limits or increases the power output of the switching converter. The modulation of the digital signal may represent duty cycle settings (and output) of a power element. In some embodiments, the digital signal may be a digitally coded value that is input to a digital decoding circuit or element of the power converter element 320 to indicate a power output setting. Other approaches are possible.

In some embodiments, such as in an example arrangement 405, an electrical circuit 480 may be used. The power control element 310 and the power converter element 320 may be implemented as an electrical circuit. The power converter element 320 may receive a V_{IN} input 451 and the control signal 455. In response to the value of the control signal 455 and the V_{IN} input 451, the power converter element 320 may provide an output, such as the V_{OUT} 453.

In various embodiments, under conditions in which no limiting is applied, the control signal 455 may normally be at a high voltage level, such as through the operation of a pull up resistor 321. The pull up resistor 321 may be configured inside the power converter element 320. Alternatively, the pull up resistor 321 may be configured external to the power converter element 320. Thus, a high voltage level of the control signal 455 indicates that the power converter element 320 is passing all the power it receives. Alternatively, the high voltage level of the control signal 455 may indicate that the power converter element 320 is converting/passing a maximum amount of power, which may be less than the power received by the power converter element. In such embodiments, the control signal 455 may be pulled to a lower voltage by a power control circuit, which may include devices such as operational amplifiers. As one or more of the control devices pull the voltage level on control signal 455 low, the power that the power converter element 320 is passing is reduced. Alternatively, the V_{OUT} 453 output may be expressed as an output current. In such embodiments, the application of control may be associated with a normally high voltage level of the control signal 455 being pulled low. In some embodiments, the application of control may be associated with a normally low voltage level being raised.

During operation of the arrangement 405, the batteries BATT1 151 and the BATT2 153 may be provided with current sensing circuits that may include a sense resistor R1 465 and a sense resistor R2 466 respectively (e.g., on a BATT1 151 side and a BATT2 153 side). The sense resistor R1 465 and the sense resistor R2 466 may be coupled across the inverting and non-inverting terminals of an operational amplifier U1 463 and an operational amplifier U2 464, respectively. As the batteries charge and discharge, the current through the sense resistor R1 465 and the sense resistor R2 466 may provide a voltage drop of varying magnitude and polarity. The respective voltage drops across the sense resistor R1 465 and the sense resistor R2 466 results in the generation of varying respective outputs on the operational amplifier U1 463 and the operational amplifier U2 464 (e.g., representing the respective charge/discharge currents of BATT1 151 and BATT2 153). The respective outputs of the operational amplifier U1 463 and the operational amplifier U2 464 may be provided to current difference amplifier circuits. For example, the respective outputs of the operational amplifier U1 463 and the operational amplifier U2 464 may be applied to the inverting terminals of an operational amplifier U3 469 and an operational amplifier U4 470, enabling the devices to produce a difference signal based on the actual currents compared to the respective current thresholds.

On the BATT1 151 side, the operational amplifier U3 469 may receive the output of the operational amplifier U1 463 indicating the current in the BATT1 151. For discussion purposes, the current in the BATT1 151 may be a discharge current. However, depending on the operational state of the system, the current in the BATT1 151 may be a charge or a discharge current. The output of the operational amplifier U1 463 may be received at the inverting terminal of the operational amplifier U3 469. The non-inverting terminal of the operational amplifier U3 469 may be provided with a current threshold reference, such as a MAX_I_DISCHARGE BATT1 threshold reference 467. The current threshold reference may be provided as a voltage level applied to the non-inverting terminal of the operational amplifier U3 469.

On the BATT2 153 side, the operational amplifier U4 470 may receive the output of the operational amplifier U2 464 indicating the current in the BATT2 153. For discussion purposes, the current in the BATT2 153 may be a charge current. However, depending on the operational state of the system, the current in the BATT2 153 may be a charge or a discharge current. The output of the operational amplifier U2 464 may be received at the inverting terminal of the operational amplifier U4 470. The non-inverting terminal of the operational amplifier U4 470 may be provided with a current threshold reference, such as a MAX_I_CHARGE BATT2 threshold reference 468. The current threshold reference may be provided as a voltage level, which may be applied to the non-inverting terminal of the operational amplifier U4 470.

In various embodiments, the voltage level of the current threshold references may be obtained through experimentation. Based on the current through the BATT1 151 and the corresponding voltage developed across the sense resistor R1 465, a specific voltage-current profile for the BATT1 151 may become known (e.g., based on the resistance value of the sense resistor R1 465). A voltage level of the current threshold reference, such as the MAX_I_DISCHARGE BATT1 threshold reference 467, may be determined. When the desired voltage setting or level of the current threshold reference is known, the MAX_I_DISCHARGE BATT1 threshold reference 467 may be provided as a fixed voltage value, such as a voltage provided from a voltage divider circuit (not shown) or a variable value such as a variable voltage source (not shown).

Similarly, based on the current through the BATT2 153 and the corresponding voltage developed across the sense resistor R2 466, a specific voltage-current profile for the BATT2 153 may become known (e.g., based on the resistance value of the sense resistor R2 466). A voltage level of the current threshold reference, such as the MAX_I_CHARGE BATT2 threshold reference 468, may be determined. When the desired voltage setting or level of the current threshold reference is known, the MAX_I_CHARGE BATT2 threshold reference 468 may be provided as a fixed voltage value, such as a voltage provided from a voltage divider circuit (not shown) or a variable value such as a variable voltage source (not shown).

During conditions in which the output of the operational amplifier U1 463 (e.g., the actual current of the BATT1 151) is less than the MAX_I_DISCHARGE BATT1 threshold reference 467, the output of the operational amplifier U3 469 may not be active (e.g., output is allowed to float high). In a condition in which the output of the operational amplifier U1 463 increases and exceeds the MAX_I_DISCHARGE BATT1 threshold reference 467, the output of the operational amplifier U3 469 may become active. In some embodiments the output level of the operational amplifier U3 469 may increase (i.e., decrease in voltage) proportional to the output level of the operational amplifier U1 463. As the magnitude by which the current in the BATT1 151 exceeds the current threshold reference increases, the output of the operational amplifier U3 469 correspondingly increases.

Similarly, during conditions in which the output of the operational amplifier U2 464 (e.g., the actual current of the BATT2 153) is less than the MAX_I_CHARGE BATT2 threshold reference 468, the output of the operational amplifier U4 470 may not be active (e.g., output is allowed to float high). In a condition in which the output of the operational amplifier U2 464 increases and exceeds the MAX_I_CHARGE BATT2 threshold reference 468, the output of the operational amplifier U4 470 may become active. In some embodiments the output level of the operational amplifier U4 470 may increase (i.e., decrease in voltage) proportional to the output level of the operational amplifier U2 464. As the magnitude by which the current in the BATT2 153 exceeds the current threshold reference increases, the output of the operational amplifier U4 470 correspondingly increases.

Referring to the BATT1 151, when the output of the operational amplifier U3 469 changes to exceed the bias voltage of diode 471, the output of the operational amplifier U3 469 may be electrically coupled through the forward biased diode to the control line associated with the control signal 455 to control the output of the power converter element 320. Since other outputs may also be generated and electrically coupled to the control line associated with the control signal 455, the bias voltage required to forward bias the diode 471 may change. The output of the operational amplifier U3 469 may be applied to the control line associated with the control signal 455 only if the output exceeds the other control outputs that are also electrically coupled to the control line associated with the control signal 455.

Similarly, referring to the BATT2 153, when the output of the operational amplifier U4 470 changes to exceed the bias voltage of diode 472, the output of the operational amplifier U4 470 may be electrically coupled through the forward biased diode to the control line associated with the control signal 455 to control the output of the power converter element 320. Since other outputs may also be generated and electrically coupled to the control line associated with the control signal 455, the bias voltage required to forward bias the diode 472 may change. The output of the operational amplifier U4 470 may be applied to the control line associated with the control signal 455 only if the output exceeds the other control outputs that are also electrically coupled to the control line associated with the control signal 455.

Simultaneously with monitoring the current values, the voltages of the BATT1 151 and the BATT2 153 may be monitored by voltage difference amplifier circuits that may include an operational amplifier U5 475 and an operational amplifier U6 476, respectively. On the BATT1 151 side, the V_{IN} input 451 may be coupled to the non-inverting terminal of the operational amplifier U5 475. A voltage threshold reference value, such as a MIN_V1_BATT1 threshold 473 may be applied to the inverting terminal of the operational amplifier U5 475. When the voltage level of the V_{IN} input 451, which corresponds to the voltage of the BATT1 151, drops below the MIN_V1_BATT1 threshold 473, the operational amplifier U5 475 may generate an output level that is proportional to the difference between the actual voltage (e.g., the V_{IN} input 451) and the voltage threshold reference (e.g., the MIN_V1_BATT1 threshold 473).

When the output of the operational amplifier U5 475 changes to exceed the bias voltage of diode 477, the output of the operational amplifier U5 475 may be electrically coupled through the forward biased diode to the control line associated with the control signal 455 to control the output of the power converter element 320. Since other outputs may also be generated and electrically coupled to the control line associated with the control signal 455, the bias voltage required to forward bias the diode 477 may change. The output of the operational amplifier U5 475 may be applied to the control line associated with the control signal 455 only if the output exceeds the other control outputs electrically coupled to the control line associated with the control signal 455.

On the BATT2 153 side, the V_{OUT} 453 may be coupled to the inverting terminal of the operational amplifier U6 476. A voltage threshold reference value, such as a MAX_V2_BATT2 threshold 474 may be applied to the non-inverting terminal of the operational amplifier U6 476. When the voltage level of the V_{OUT} 453, which corresponds to the voltage of the BATT2 153 rises above the MIN_V1_BATT1 threshold 473, the operational amplifier U5 475 may generate an output level that is proportional to the difference between the actual voltage (e.g., the V_{IN} input 451) and the voltage threshold reference (e.g., the MIN_V1_BATT1 threshold 473).

When the output of the operational amplifier U6 476 changes to exceed the bias voltage of diode 478, the output of the operational amplifier U5 475 may be electrically coupled through the forward biased diode to the control line associated with the control signal 455 to control the output of the power converter element 320. Since other outputs may also be generated and electrically coupled to the control line associated with the control signal 455, the bias voltage required to forward bias the diode 478 may change. The output of the operational amplifier U6 476 may be applied to the control line associated with the control signal 455 only if the output exceeds the other control outputs electrically coupled to the control line associated with the control signal 455.

In various embodiments, the outputs from the operational amplifier U3 469, the operational amplifier U4 470, the operational amplifier U5 475, and the operational amplifier U6 476 may “compete” to determine which of the outputs will result in the lowest output for the power converter element 320. The resulting reduction in the output of the power converter element 320 may assure that power from the BATT1 151, the BATT2 153 and any charging source is efficiently allocated. Damage to batteries, reduction in the energy capacity or useful charge, and other disadvantages may be prevented or avoided.

In some embodiments, such as in an example arrangement 407, logical elements may be used. The power control element 310 and the power converter element 320 may be implemented with logical elements, such as in the processor 410. The processor 410 may be programmed with various comparison algorithms that continuously or periodically monitor actual values of the charge and discharge currents, voltages and possibly other parameters of the BATT1 and the BATT1. The values may be stored within registers of the processor 410. The processor 410 may further be configured with registers that store reference values. Alternatively, the processor 410 may be configured such that coded values representing the threshold values are provided. The processor 410 may perform mathematical operations to compare the values and provide an output indicative of differences, absolute values, or other derivative values from the comparison. The processor 410 may use general purpose input output (GPIO) lines, A/D converter (ADC) lines or other similar capabilities to read actual voltage values and convert the values into digital format for digital processing within the processor 410. The processor 410 may also output comparison results either as digital values or analog values depending on the requirements. The processor 410 may work in combination with analog electrical circuits to perform at least part of the operations. The processor 410 may receive the outputs of some or all of the operational amplifiers U1 463-U6 476 and conduct comparisons of the output values to determine what control measures are required for the power converter element.

An actual BATT1 discharge current may be input to a logical comparison block 483. The BATT1 discharge current may be input to a GPIO input on the processor 410 or may be received as a digital value from an external converter. The logical comparison block 483 may also be provided with a reference threshold value for the MAX_I_DISCHARGE threshold discharge current for the BATT1. The reference value may also be a stored digital value, an analog voltage established by an external reference circuit, a hard coded reference constant, etc. The logical comparison block 483 may compare the input values to determine whether the actual discharge current of BATT1 exceeds the reference value. A comparison result may be generated by the logical comparison block 483, which may be compared by the processor 410 with other comparison results.

An actual BATT2 charge current may be input to a logical comparison block 485. The BATT2 charge current may be input to a GPIO input on the processor 410 or may be received as a digital value from an external converter. The logical comparison block 485 may also be provided with a reference threshold value for the MAX_I_CHARGE threshold charge current for the BATT2. The logical comparison block 485 may compare the input values to determine whether the actual charge current of BATT2 exceeds the reference value. A comparison result may be generated by the logical comparison block 485, which may be compared by the processor 410 with other comparison results.

An actual V1 voltage for BATT1 may be input to a logical comparison block 487. The V1 voltage for BATT1 may be input to a GPIO input on the processor 410 or may be received as a digital value from an external converter. The logical comparison block 487 may also be provided with a reference threshold value for the MIN_V1_BATT1 threshold voltage for the BATT1. The logical comparison block 487 may compare the input values to determine whether the actual voltage level of BATT1 is below the minimum voltage reference value. A comparison result may be generated by the logical comparison block 487, which may be compared by the processor 410 with other comparison results.

An actual V2 voltage for BATT2 may be input to a logical comparison block 489. The V1 voltage for BATT1 may be input to a GPIO input on the processor 410 or may be received as a digital value from an external converter. The logical comparison block 489 may also be provided with a reference threshold value for the MAX_V2_BATT2 threshold voltage for the BATT2. The logical comparison block 489 may compare the input values to determine whether the actual voltage level of BATT2 exceeds the maximum voltage reference value. A comparison result may be generated by the logical comparison block 489, which may be compared by the processor 410 with other comparison results.

The results may be generated continuously or periodically by the logical comparison blocks 483, 485, 487, and 489 and the processor 410 may generate the control signal 455, which may be provided to the power converter element 320. The power converter element 320 may control a power output such as the V_{OUT} 453.

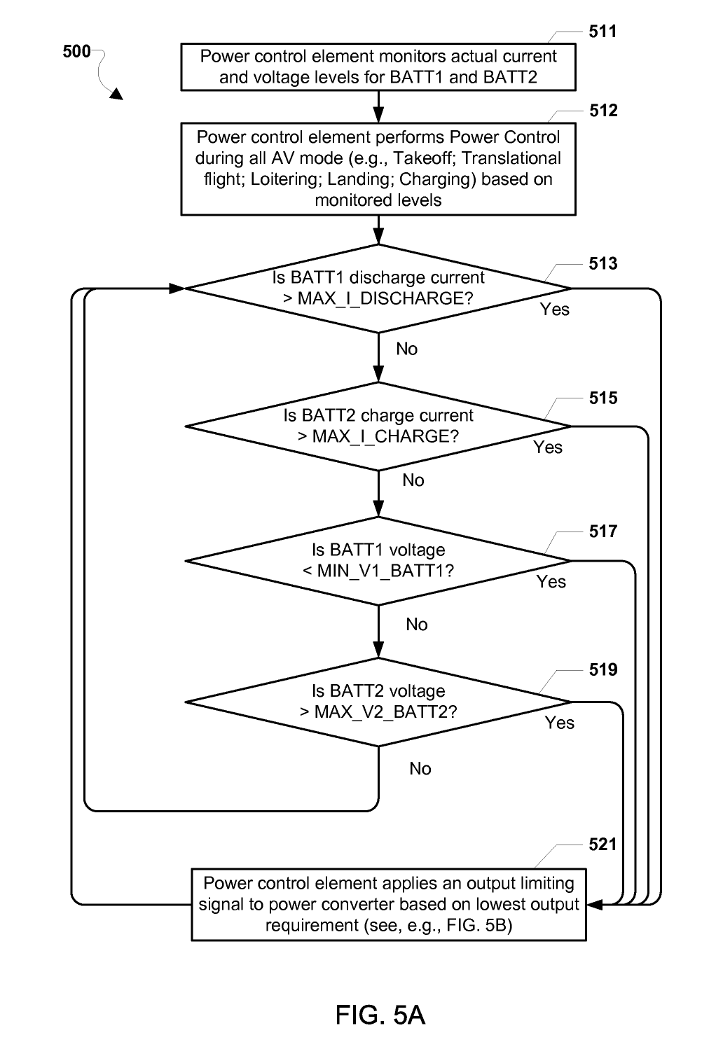

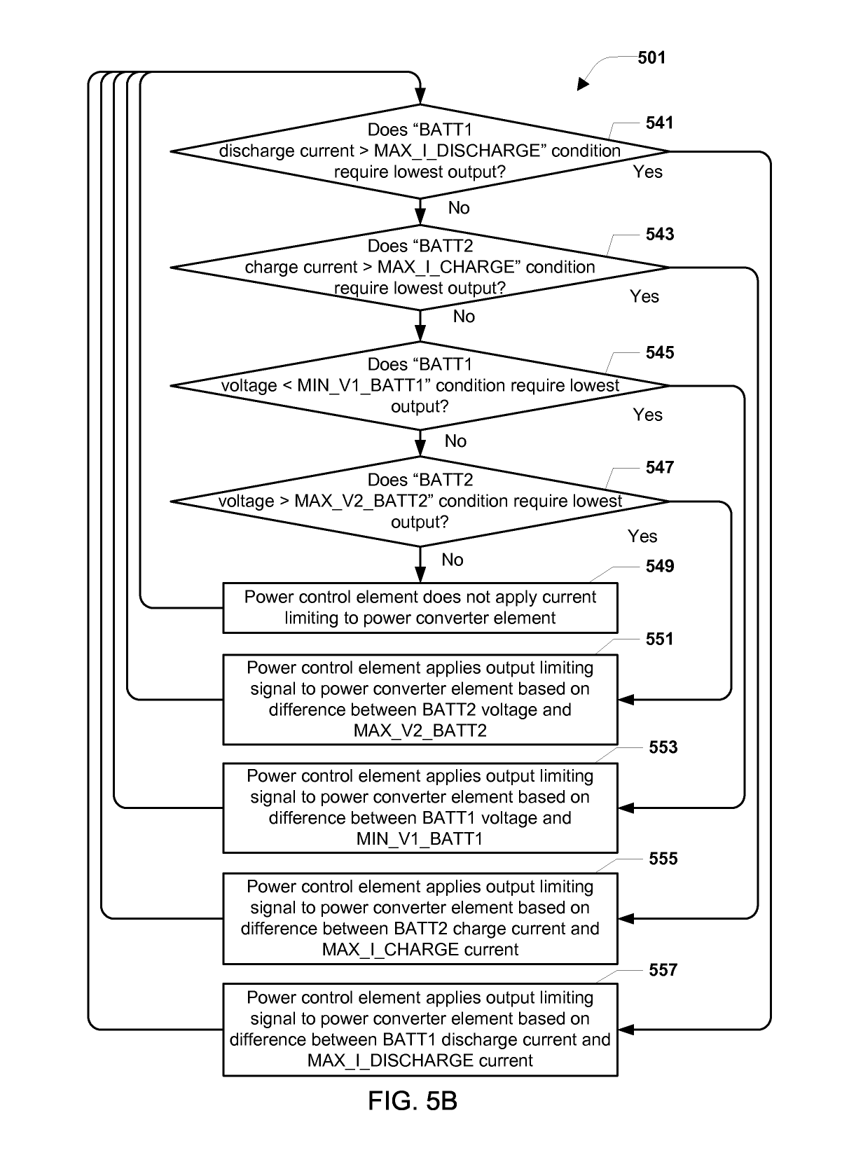

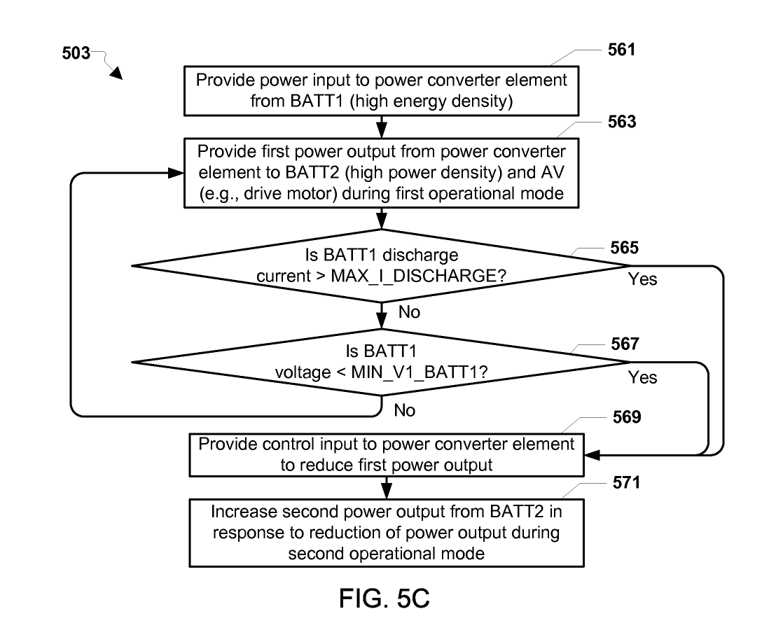

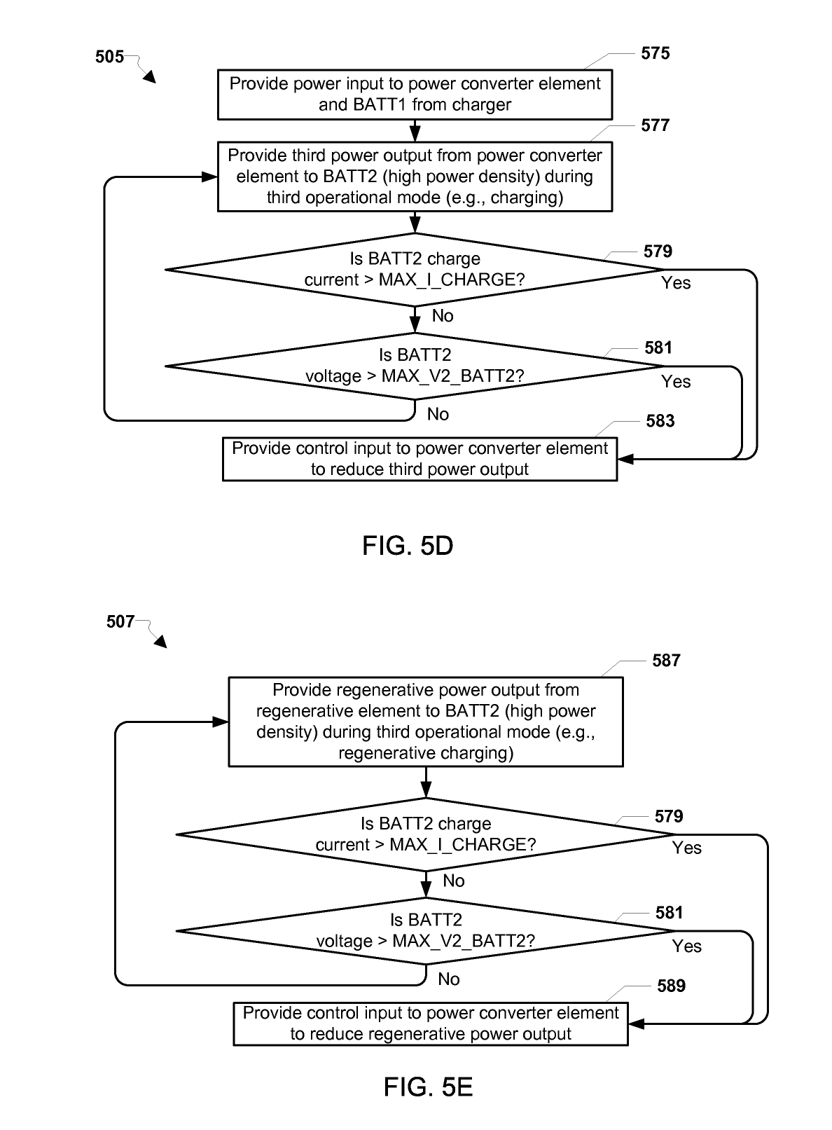

FIGS. 5A-5E illustrate various methods for managing the power to the batteries according to various embodiments. With reference to FIGS. 1A-5E, the various methods may be implemented by a power control module 150 and/or elements thereof.

FIG. 5A illustrates a method 500 for managing the power in an autonomous vehicle in accordance with some embodiments. With reference to FIGS. 1A-5A, the method 500 may be implemented in a power control element (e.g., power control element 310) of an autonomous vehicle (e.g., the autonomous vehicle 100) having two batteries, such as a high energy density battery for powering low to moderate demand sustained operations (e.g., the BATT1 151) and a high power density battery for powering high demand peak operations (e.g., the BATT2 153).

In block 511, a power control element (e.g., power control element 310), which may be a processor, a controller, a control circuit, a logic circuit, etc., may monitor current and voltage levels of the batteries (e.g., BATT1 and BATT2).

In block 512, the power control element may perform power control during all operational modes of the autonomous vehicle, such as takeoff, translational flight, loitering or hovering, landing, regenerative charging, and stationary charging based on the monitored levels. In some embodiments, providing control may refer to passing non-limited power from the first battery BATT1 through a power converter element (e.g., the power converter element 320) to BATT2 and the autonomous vehicle to power the autonomous vehicle. In some embodiments, providing control may refer to limiting the power provided by the BATT1 and the power converter element such that BATT2 may provide power to the autonomous vehicle when current demands exceed the ratings for BATT1. In some embodiments, providing control may refer to limiting the charging power provided to the BATT1 by passing most or all of the charging power through the power converter element such that BATT2 may be fully charged before BATT1. In some embodiments, providing control may refer to inhibiting regenerative power from being passed in reverse (e.g., at least initially) through the power converter element to BATT1 during regenerative charging, such as when the drone motor provides power during descents, reverse rotor operations, etc.

In determination block 513, the power control element may determine whether the discharge current of the BATT1 is greater than a threshold discharge current, such as a MAX_I_DISCHARGE threshold current. In response to determining that the discharge current of the BATT1 is greater than a threshold discharge current (i.e., determination block 513=“Yes”), the power control element may apply an output limiting signal to a power converter element in block 521. The power converter element may limit the output of power based on a lowest output requirement among several contenders for output control as described. The output limiting signal limits the power output by the power converter element and limits the current drawn from BATT1 to safe levels. Limiting the output of the power converter element may also shift the sourcing of the power demand from BATT1 to BATT2. In response to determining that the discharge current of the BATT1 is not greater than a threshold discharge current (i.e., determination block 513=“No”), the power control element may determine whether the BATT2 charge current is greater than a threshold charge current such as a MAX_I_CHARGE threshold current in determination block 515.

In response to determining that the charge current of the BATT2 is greater than the threshold charge current (i.e., determination block 515=“Yes”), the power control element may apply an output limiting signal to the power converter element that outputs power in block 521. In some embodiments, the power control element may determine the charge current for BATT2 and limit the output of the power converter element during charging operations such as using an external charger when the autonomous vehicle is not in flight. Alternatively, these operations may be performed in flight during regenerative charging in configurations where the regenerative output of the autonomous vehicle motor is applied through the power converter element.

In response to determining that the charge current of the BATT2 is not greater than the threshold discharge current (i.e., determination block 515=“No”), the power control element may determine whether the BATT1 voltage is less than a threshold minimum voltage such as a MIN_V1_BATT1 threshold voltage in determination block 517.

In response to determining that the voltage of the BATT1 is less than the threshold minimum voltage (i.e., determination block 517=“Yes”), the power control element may apply an output limiting signal to the power converter element that outputs power in block 521. The output limiting signal limits the power output by the power converter element and prevents overdischarge of BATT1. Limiting the output of the power converter element may also shift the sourcing of the power demand from BATT1 to BATT2.

In response to determining that the voltage of the BATT1 is not less than the threshold minimum voltage (i.e., determination block 517=“No”), the power control element may determine whether the BATT2 voltage is greater than a threshold maximum charge voltage such as a MAX_V2_BATT2 threshold voltage in determination block 519.

In response to determining that the charge voltage of the BATT2 is greater than the threshold maximum voltage (i.e., determination block 519=“Yes”), the power control element may apply an output limiting signal to the power converter element that outputs power in block 521. In some embodiments, the power control element may determine the charge voltage for BATT2 and limit the output of the power converter element during charging operations such as using an external charger when the autonomous vehicle is not in flight. In some embodiments, these operations may be performed in flight during regenerative charging in configurations in which the regenerative output of the autonomous vehicle motor is applied through the power converter element.

In response to determining that the charge voltage of the BATT2 is not less than the threshold maximum charge voltage (i.e., determination block 519=“No”), the power control element may return to determination block 513. Further, after power control is applied in block 521, the power control element may return to determination block 513.

FIG. 5B illustrates a method 501 for managing the power in an autonomous vehicle in accordance with some embodiments. With reference to FIGS. 1A-5B, the method 501 may be implemented in a power control element (e.g., power control element 310) of an autonomous vehicle (e.g., the autonomous vehicle 100) using two batteries, such as a high energy density battery for powering low to moderate demand sustained operations (e.g., the BATT1 151) and a high power density battery for powering high demand peak operations (e.g., the BATT2 153). The power control element may be a processor, a controller, a control circuit, a logic circuit, etc., may perform the operations of managing the batteries (e.g., BATT1 and BATT2).

In determination block 541, the power control element may determine whether a first condition, such as the BATT1 discharge current being greater than the MAX_I_DISCHARGE condition, requires the lowest output from the power converter element from among contending output lowering conditions.

In response to determining that the first condition requires the lowest power control output (i.e., determination block 541=“Yes”), the power control element may apply an output limiting signal to a power converter element that outputs power in block 557. The power control element may apply output limiting signal to the power converter element based on difference between an actual BATT1 discharge current and a MAX_I_DISCHARGE threshold current reference. In some embodiments the measured BATT1 current may exceed the maximum discharge threshold during flight operations requiring a peak power demand (e.g., takeoff). When the output of the power converter element is limited, more of the peak demand may be absorbed by the BATT2, which is specifically configured to meet high peak power demands.

In response to determining that the first condition does not require the lowest power control output (i.e., determination block 541=“No”), the power control element may determine whether a second condition, such as the BATT2 charge current being greater than the MAX_I_CHARGE condition, requires the lowest output from the power converter element from among contending output lowering conditions in determination block 543.

In response to determining that the second condition requires the lowest power control output (i.e., determination block 543=“Yes”), the power control element may apply an output limiting signal to the power converter element that outputs power in block 555. The power control element may apply output limiting signal to the power converter element based on difference between an actual BATT2 charge current and a MAX_I_CHARGE threshold current reference. In some embodiments, the measured BATT2 current may exceed the maximum charge current threshold during charging or during flight operations where regenerative power is produced. When the output of the power converter element is limited, more of the charging power may be absorbed by the BATT1. Also, by limiting the output of the power converter element during charging, it may be possible to prevent exceeding the ratings of BATT2.

In response to determining that the second condition does not require the lowest power control output (i.e., determination block 543=“No”), the power control element may determine whether a third condition, such as the BATT1 voltage being less than the MIN_V1_BATT1 condition, requires the lowest output from the power converter element from among contending output lowering conditions in determination block 545.

In response to determining that the third condition requires the lowest power control output (i.e., determination block 545=“Yes”), the power control element may apply an output limiting signal to the power converter element that outputs power in block 553. The power control element may apply output limiting signal to the power converter element based on difference between an actual BATT1 voltage and a MIN_V1_BATT1 threshold voltage reference. In some embodiments, the measured BATT1 voltage may fall below the minimum threshold voltage during flight operations requiring a peak power demand (e.g., takeoff). When the output of the power converter element is limited, more of the peak demand may be absorbed by the BATT2, which is specifically configured to meet high peak power demand.

In response to determining that the third condition does not require the lowest power control output (i.e., determination block 545=“No”), the power control element may determine whether a fourth condition, such as the BATT2 voltage being greater than the MAX_V2_BATT2 condition, requires the lowest output from the power converter element from among contending output lowering conditions in determination block 547.

In response to determining that the fourth condition requires the lowest power control output (i.e., determination block 547=“Yes”), the power control element may apply an output limiting signal to the power converter element that outputs power in block 551. The power control element may apply output limiting signal to the power converter element based on difference between an actual BATT2 voltage and a MAX_V2_BATT2 threshold voltage reference. In some embodiments, the measured BATT2 current may exceed the maximum charge current threshold during charging or during flight operations where regenerative power is produced. When the output of the power converter element is limited, more of the charging power may be absorbed by the BATT1. Also, by limiting the output of the power converter element during charging, it may be possible to prevent exceeding the ratings of the BATT2.

In response to determining that the fourth condition does not require the lowest power control output (i.e., determination block 547=“No”), the power control element may apply no current limiting in block 549, and may return to determination block 541.

FIG. 5C illustrates a method 503 for managing power in an autonomous vehicle in accordance with some embodiments. With reference to FIGS. 1A-5C, the method 503 in a power control element (e.g., power control element 310) of an autonomous vehicle (e.g., the autonomous vehicle 100) using two batteries, such as a high energy density battery for powering low to moderate demand sustained operations (e.g., the BATT1 151) and a high power density battery for powering high demand peak operations (e.g., the BATT2 153). The power control element may be a processor, a controller, a control circuit, a logic circuit, etc., may monitor current and voltage levels of the batteries (e.g., BATT1 and BATT2), a power converter element (e.g., power converter element 320), or combinations of these elements.

In block 561, the power control element may provide a power input to a power converter element from the BATT1, which is a high energy density battery for providing even levels of power over a sustained duration. The BATT1 may be suitable for power demands that do not exceed the current supply rating or discharge current threshold (e.g., MAX_I_DISCHARGE).

In block 563, the power converter element may provide a first power output to the BATT2 and the drive motor of the autonomous vehicle during a first operational mode. The first operational mode may include a translational flight mode, a hovering flight mode, or other flight mode not typically associated with high peak power demands. The converter may be a part-time buck converter, a full-buck converter, a full-time boost converter, or other type of converter or regulator that takes the power input provided from the BATT1 and provides a controlled output. The control may be full-time or part-time. In some embodiments, for full time control, the power converter element may provide control at all times, even though some conditions may not require an actual change or adjustment in output. In some embodiments, for part-time control, the power converter element may provide conversion only when various operating parameters are operating outside of acceptable parameters or thresholds.

In determination block 565, the power control element may determine whether the discharge current of the BATT1 is greater than a maximum discharge current threshold such as MAX_I_DISCHARGE threshold. In response to determining that the discharge current of the BATT1 is greater than the maximum discharge current threshold (i.e., determination block 565=“Yes”), the power control element may provide a control input to the power converter element to reduce the first power output of the power converter element in block 569. By reducing the first output of the power converter element, less output is required from the BATT1 thus limiting the discharge of the BATT1 to a safe level. In response to determining that the discharge current of the BATT1 is not greater than the maximum discharge current threshold (i.e., determination block 565=“No”), the power control element may determine whether the BATT1 voltage is less than a minimum voltage threshold, such as MIN_V1_BATT1 in determination block 567.

In response to determining that the BATT1 voltage is less than a minimum voltage threshold, such as MIN_V1_BATT1 (i.e., determination block 567=“Yes”), the power control element may provide a control input to the power converter element to reduce the first power output of the power converter element in block 569. In response to determining that the BATT1 voltage is not less than the minimum voltage threshold, such as MIN_V1_BATT1 (i.e., determination block 567=“No”), the power converter element may continue to provide a first power output to BATT2 and the autonomous vehicle in block 563.

In block 571, in response to the reduction of the first power output of the power converter element (block 569), a second power output, such as a power output from the BATT2 may be increased during a second operational mode. Such increase in the power output from the BATT2 may result from a high peak power demand from the load (e.g., autonomous vehicle 100) during a flight operation such as takeoff, etc.

FIG. 5D illustrates a method 505 for managing power in an autonomous vehicle in accordance with some embodiments. With reference to FIGS. 1A-5D, the method 505 may be implemented in a power control element (e.g., power control element 310) of an autonomous vehicle (e.g., the autonomous vehicle 100) using two batteries, such as a high energy density battery for powering low to moderate demand sustained operations (e.g., the BATT1 151) and a high power density battery for powering high demand peak operations (e.g., the BATT2 153) during charging. The power control element may be a processor, a controller, a control circuit, a logic circuit, etc., may monitor current and voltage levels of the batteries (e.g., BATT1 and BATT2), a power converter element (e.g., power converter element 320), or combinations of these elements.

In block 575, the power control element may provide a power input to a power converter element and the BATT1 from a charger, such as an external charger (e.g., charger 160). During charging, the power control element may, at least initially provide most of the charging power to charge the BATT2.

In block 577, a third power output may be provided from the power converter element to the BATT2 during the third operational mode (e.g., charging from external charger).

In determination block 579, the power control element may determine whether the charge current of BATT2 is greater than a maximum charge current threshold such as MAX_I_CHARGE threshold. In response to determining that the charge current of BATT2 is greater than the maximum charge current threshold (i.e., determination block 579=“Yes”), the power control element may provide a control input to the power converter element to reduce the third power output of the power converter element in block 583. By reducing the third output of the power converter element, most or all of the charging power is provided to the BATT1 providing a recharging opportunity for the BATT1. In response to determining that the charge current of BATT2 is not greater than the maximum charge current threshold (i.e., determination block 579=“No”), the power control element may determine whether the BATT2 voltage is greater than a maximum voltage threshold, such as MAX_V2_BATT2 in determination block 581.

In response to determining that the BATT2 voltage is greater than the maximum voltage threshold, such as MAX_V2_BATT2 (i.e., determination block 581=“Yes”), the power control element may provide a control input to the power converter element to reduce the third power output of the power converter element in block 583. By reducing the third output of the power converter element, most or all of the charging power is provided to the BATT1 providing a recharging opportunity for the BATT1. In response to determining that the BATT2 voltage is not greater than the maximum voltage threshold, such as MAX_V2_BATT2 (i.e., determination block 581=“No”), the power converter element may continue to provide the third power output to BATT2 in block 577.

FIG. 5E illustrates a method 507 for managing power in an autonomous vehicle in accordance with some embodiments. With reference to FIGS. 1A-5E, the method 507 may be implemented in a power control element (e.g., power control element 310) of an autonomous vehicle (e.g., the autonomous vehicle 100) using two batteries, such as a high energy density battery for powering low to moderate demand sustained operations (e.g., the BATT1 151) and a high power density battery for powering high demand peak operations (e.g., the BATT2 153) during regenerative charging. The power control element may be a processor, a controller, a control circuit, a logic circuit, etc., may monitor current and voltage levels of the batteries (e.g., BATT1 and BATT2), a power converter element (e.g., power converter element 320), a regenerative element (not shown) or combinations of these elements.

In block 587, a regenerative charging element associated with one or more of the drive motors 102 of the autonomous vehicle 100 may provide a regenerative power output to the BATT2 during the third mode (e.g., charging mode). In addition, in some embodiments, the regenerative power may be applied to the power converter element and the BATT1. The regenerative power may be applied to the BATT2 until the BATT2 is fully charged (e.g., as determined by voltage/current monitoring). When the BATT2 is fully charged, the power converter element may operate in a reverse mode to enable the regenerative power to be applied to the BATT1 (e.g., through the “input” node of the power converter element). Alternatively, the regenerative power may be configured to be applied in the same manner as an external charger (e.g., the charger 160) described with respect to the method 505, such on the input side of the power converter element. During charging, the power control element may operate at least initially to provide most of the charging power to charge the BATT2. At least initially, the power converter element will inhibit power to be directed to the BATT1.

Determination blocks 579 and 581 operate as described, therefore the following description is simplified for brevity. In response to determining that the charge current of BATT2 is greater than the maximum charge current threshold (i.e., determination block 579=“Yes”), the power control element may provide a control input to the power converter element to reduce the regenerative power output of the regenerative element in block 589. Reducing the regenerative power output may include operating the power converter element in reverse such that the regenerative power is applied to the BATT1. By reducing the regenerative power output of the regenerative element, most or all of the regenerative charging power is shifted to the BATT1 providing a recharging opportunity for the BATT1. In response to determining that the charge current of BATT2 is not greater than the maximum charge current threshold (i.e., determination block 579=“No”), the power control element may determine whether the BATT2 voltage is greater than a maximum voltage threshold, such as MAX_V2_BATT2 in determination block 581.

In response to determining that the BATT2 voltage is greater than the maximum voltage threshold, such as MAX_V2_BATT2 (i.e., determination block 581=“Yes”), the power control element may provide a control input to the power converter element to reduce the regenerative power output of the regenerative element in block 589. In response to determining that the BATT2 voltage is not greater than the maximum voltage threshold, such as MAX_V2_BATT2 (i.e., determination block 581=“No”), the power converter element may continue to provide a regenerative power output to BATT2 in block 587.

The various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order in which the operations are performed.

The elements of any of the embodiments illustrated and described herein are not intended to be limited only to the embodiments in which they are illustrated and described. The elements of any of the embodiments may be used in any combination with other elements from any of the embodiments.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an,” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the described media are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method for managing power during a plurality of operational modes in an autonomous vehicle, comprising:
providing a power input from a first battery to a power converter element;
providing a first power output from the power converter element to power a second battery and the autonomous vehicle during a first operational mode of the plurality of operational modes;
determining whether one or both of a maximum discharge current threshold and a minimum voltage threshold of the first battery have been exceeded;
providing a control input to the power converter element to reduce the first power output in response to determining that one or both of the maximum discharge current threshold and the minimum voltage threshold of the first battery has been exceeded; and
increasing a second power output from the second battery to power the autonomous vehicle during a second operational mode of the plurality of operational modes in response to the reduction of the first power output.

2. The method of claim 1, further comprising:
providing a charging power output to the second battery during a third operational mode of the plurality of operational modes;
determining whether one or both of a maximum charge current threshold and a maximum voltage threshold of the second battery have been exceeded;
providing a control input to the power converter element to reduce the charging power output to the second battery in response to determining that one or both of the maximum charge current threshold and the maximum voltage threshold of the second battery has been reached; and
applying the charging power output to the first battery during the third operational mode in response to the reduction of the charging power output to the second battery.

3. The method of claim 2, wherein the third operational mode comprises one of: an external charging mode, and a regenerative charging mode.

4. The method of claim 1, wherein the first battery comprises a high energy density battery and the second battery comprises a high power density battery.

5. The method of claim 4,
wherein the high energy density battery comprises one of: a lithium-ion battery, an air-aluminum battery, a fuel cell, a solar cell, and a primary lithium battery, and
wherein the high power density battery comprises one of: a double layer ultracapacitor, a lead-acid battery, and a lithium iron phosphate battery.

6. The method of claim 1, wherein the first operational mode comprises one of a translational flight mode and a loitering flight mode.

7. The method of claim 1, wherein the second operational mode comprises one of a takeoff mode and a landing mode.

8. A power control element for managing power during a plurality of operational modes in an autonomous vehicle, comprising:
a power converter element configured to be coupled to a first battery and a second battery within an autonomous vehicle, the power converter element configured to receive a first power input from the first battery and provide a first power output to the second battery and the autonomous vehicle during a first operational mode of the plurality of operational modes; and
a processor coupled to the power converter element and configured with processor-readable instructions to:
determine whether one or both of a maximum discharge current threshold and a minimum voltage threshold of the first battery have been exceeded; and
provide a control input to the power converter element to reduce the first power output in response to determining that one or both of the maximum discharge current threshold and the minimum voltage threshold of the first battery has been exceeded,
wherein a second power output from the second battery to power the autonomous vehicle is increased during a second operational mode of the plurality of operational modes in response to the reduction of the first power output.

9. The power control element of claim 8, wherein the processor is further configured with processor-readable instructions to:
determine whether one or both of the maximum charge current threshold and the maximum voltage threshold of the second battery have been exceeded during a third operational mode of the plurality of operational modes in which a charging power is output to the second battery; and
provide a control input to the power converter element to reduce the charging power output to the second battery in response to determining that one or both of a maximum charge current threshold and a maximum voltage threshold of the second battery has been reached,
wherein the charging power output is applied to the first battery during the third operational mode of the plurality of operational modes in response to the reduction of the charging power output to the second battery.

10. The power control element of claim 9, wherein the third operational mode comprises one of an external charging mode, and a regenerative charging mode.

11. The power control element of claim 8, wherein the first battery comprises a high energy density battery and the second battery comprises a high power density battery.

12. The power control element of claim 11,
wherein the high energy density battery comprises one of: a lithium-ion battery, an air-aluminum battery, a fuel cell, a solar cell, and a primary lithium battery, and
wherein the high power density battery comprises one of: a double layer ultracapacitor, a lead-acid battery, and a lithium iron phosphate battery.

13. The power control element of claim 8, wherein the first operational mode comprises one of a translational flight mode and a loitering flight mode.

14. The power control element of claim 8, wherein the second operational mode comprises one of a takeoff mode and a landing mode.

15. The power control element of claim 8, wherein the power converter element comprises one of: a part-time buck converter, a buck-boost converter, a full-time boost converter; a linear current limiter; a power regulator; and a bidirectional power converter.

16. A device for managing power during a plurality of operational modes in an autonomous vehicle, comprising:
means for receiving a power input from a first battery;
means for providing a first power output to power to a second battery and the autonomous vehicle during a first operational mode of the plurality of operational modes;
means for determining whether one or both of a maximum discharge current threshold and a minimum voltage threshold of the first battery have been exceeded;
means for providing a control input to a power converter element to reduce the first power output in response to determining that one or both of the maximum discharge current threshold and the minimum voltage threshold of the first battery has been exceeded; and
means for increasing a second power output from the second battery to power the autonomous vehicle during a second operational mode of the plurality of operational modes in response to the reduction of the first power output.

17. A circuit for managing power during a plurality of operational modes in an autonomous vehicle, comprising:
a power converter element configured to be coupled to a first battery and a second battery of an autonomous vehicle, the power converter element configured to receive a first power input from the first battery and provide a first power output to the second battery and the autonomous vehicle during a first operational mode of the plurality of operational modes;
a first current difference amplifier circuit configured to compare a first battery current signal with a maximum discharge current threshold and output a first battery current difference signal in response to the maximum discharge current threshold being exceeded;
a first voltage difference amplifier circuit configured to compare a first battery voltage in the first battery with a minimum voltage threshold of the first battery and output a first battery voltage difference signal in response to the minimum voltage threshold being exceeded; and
a control signal circuit configured to provide a control input to the power converter element to reduce the first power output in response to the output of one or both of the first battery current difference signal and the first battery voltage difference signal during a second operational mode of the plurality of operational modes.

18. The circuit of claim 17, further comprising a current sensing circuit configured to sense a first battery current in the first battery and output the first battery current signal in response to sensing the first battery current.

19. The circuit of claim 17,
wherein the first battery current difference signal is proportional to a difference between the first battery current signal and the maximum discharge current threshold, and
wherein the first battery voltage difference signal is proportional to the difference between the first battery voltage and the minimum voltage threshold.

20. The circuit of claim 17, further comprising:
a second current difference amplifier circuit configured to compare a second battery current signal with a maximum charge current threshold and output a second battery current difference signal in response to the maximum charge current threshold being exceeded during a third operational mode of the plurality of operational modes in which a charging power is output to the second battery; and
a second voltage difference amplifier circuit configured to compare a second battery voltage in the second battery with a maximum voltage threshold of the second battery and output a second voltage difference signal in response to the minimum voltage threshold being exceeded during the third operational mode of the plurality of operational modes,
wherein the control signal circuit is configured to provide the control input to the power converter element to reduce the charging power output to the second battery in response to the output of one or both of the second battery current difference signal and the second battery voltage difference signal, and
wherein the charging power output is applied to the first battery during the third operational mode of the plurality of operational modes in response to the reduction of the charging power output to the second battery.

21. The circuit of claim 20, wherein the third operational mode comprises one of an external charging mode, and a regenerative charging mode.

22. The circuit of claim 17,
wherein the first battery is a high energy density battery comprises one of: a lithium-ion battery, an air-aluminum battery, a fuel cell, a solar cell, and a primary lithium battery, and
wherein the second battery is a high power density battery comprises one of: a double layer ultracapacitor, a lead-acid battery, and a lithium iron phosphate battery.

23. The circuit of claim 17, wherein the power converter element comprises one of: a part-time buck converter; a buck-boost converter; a full-time boost converter; a linear current limiter; a power regulator; and a bidirectional power converter.
